(19) United States
(12) Patent Application Publication
(10) Pub. No.: US 2020/0053274 A1
(43) Pub. Date: Feb. 13, 2020

(54) IMAGING CONTROL METHOD AND DEVICE

(71) Applicant: SZ DJI OSMO TECHNOLOGY CO., LTD., Shenzhen (CN)

(72) Inventor: Haoyu LI, Shenzhen (CN)

(21) Appl. No.: 16/657,736

(22) Filed: Oct. 18, 2019

Related U.S. Application Data
(63) Continuation of application No. PCT/CN2017/081554, filed on Apr. 22, 2017.

(51) Int. Cl. H04N 5/232; G05D 1/00; B64C 39/02

(52) U.S. Cl. CPC H04N 5/23203; H04N 5/23216; H04N 5/23238; H04N 5/23299; B64C 2201/146; G05D 1/0016; G05D 1/0038; B64C 39/024; H04N 5/23245

(57) ABSTRACT

An imaging control method includes obtaining location point information, the location point information being determined based on angle data. The imaging control method also includes generating a control command based on the location point information, the control command including an imaging parameter. The imaging control method further includes transmitting the control command to a target device, the control command configured to control the target device to execute an imaging control process based on the imaging parameter.

### CROSS-REFERENCE TO RELATED APPLICATION

This application is a continuation application of International Application No. PCT/CN2017/081554, filed on Apr. 22, 2017, the entire content of which is incorporated herein by reference.

### TECHNICAL FIELD

The present disclosure relates to the technology field of computer and, more particularly, to an imaging control method and device.

### BACKGROUND

As the computer technology advances, unmanned aerial vehicles (“UAV”) and handheld gimbals are gradually becoming parts of people's life. Currently, either the UAV or the handheld gimbal can mount an image capturing device. Through remote controlling the UAV, a user may perform aerial photographing or aerial imaging, which provides a new photographing angle to the user. The aerial photographing may be used for photographing portraits or scenes.

However, difficulty exists in operating the UAV or the gimbal. In addition, operations for controlling the image capturing device to capture videos and images are complex, which place certain requirements on the level of operation for the user. As such, it becomes a key research topic to develop a method and device that are convenient for the user to operate, which can improve imaging efficiency and flexibility.

### SUMMARY

In accordance with an aspect of the present disclosure, there is provided an imaging control method. The imaging control method includes obtaining location point information, the location point information being determined based on angle data. The imaging control method also includes generating a control command based on the location point information, the control command including an imaging parameter. The imaging control method further includes transmitting the control command to a target device, the control command configured to control the target device to execute an imaging control process based on the imaging parameter.

In accordance with another aspect of the present disclosure, there is also provided an imaging control method. The imaging control method includes obtaining control information input through a remote control interface. The remote control interface includes one or more of an angle button, a speed button, a remote control mode switching button, or an imaging mode switching button. The imaging control method also includes generating a control command based on an operation on the remote control interface, the control command comprising an imaging parameter. The imaging control method further includes transmitting the control command to a target device, the control command configured to control the target device to execute an imaging control process based on the imaging parameter.

In the present disclosure, by obtaining location point information determined based on angle data, a control command carrying imaging parameters may be generated based on the location point information. The control command may be transmitted to a target device, such that the target device may execute an imaging control process based on the imaging parameters, thereby improving the imaging efficiency and flexibility.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is an interactive schematic diagram of an imaging method, according to an example embodiment.

FIG. 2 is a schematic illustration of an initial interface for route imaging, according to an example embodiment.

FIG. 3 is a schematic illustration of an interface for adding a point for the route imaging, according to an example embodiment.

FIG. 4 is a schematic illustration of an interface for adding multiple points for the route imaging, according to an example embodiment.

FIG. 5 is a schematic illustration of an interface showing a target device following selected points, according to an example embodiment.

FIG. 6 is a schematic illustration of an interface showing a target device arriving at a location of a selected point, according to an example embodiment.

FIG. 7 is schematic illustration of an interface for selecting a specific point to preview in route imaging, according to an example embodiment.

FIG. 8 is a schematic illustration of an interface for previewing from the specific point to a next point in route imaging, according to an example embodiment.

FIG. 9 is a schematic illustration of an interface for pausing the preview in route imaging, according to an example embodiment.

FIG. 10 is a schematic illustration of an interface form terminating the preview in route imaging, according to an example embodiment.

FIG. 11 is a schematic illustration of an interface for route imaging, according to an example embodiment.

FIG. 12 is a schematic illustration of an interface for pausing the route imaging, according to an example embodiment.

FIG. 13 is a schematic illustration of an interface for terminating the route imaging, according to an example embodiment.

FIG. 14 is a schematic illustration of an initial interface for delayed imaging, according to an example embodiment.

FIG. 15 is a schematic illustration of an interface for adjusting parameters for delayed imaging, according to an example embodiment.

FIG. 16 is a schematic illustration of an interface for adjusting a location point in delayed imaging, according to an example embodiment.

FIG. 17 is a schematic illustration of an interface for preview in delayed imaging, according to an example embodiment.

FIG. 18 is a schematic illustration of an interface for pausing or terminating the preview in delayed imaging, according to an example embodiment.

FIG. 19 is a schematic illustration of an interface showing delayed imaging is in progress, according to an example embodiment.

FIG. 20 is a schematic illustration of an interface showing delayed imaging is paused, according to an example embodiment.

FIG. 21 is a schematic illustration of an interface showing delayed imaging is terminated, according to an example embodiment.

FIG. 22 is a schematic illustration of an interface for panorama imaging, according to an example embodiment.

FIG. 23 is a schematic illustration of an interface showing following selected points in panorama imaging, according to an example embodiment.

FIG. 24 is a schematic illustration of an interface showing arriving at selected points for panorama imaging, according to an example embodiment.

FIG. 25 is a schematic illustration of an interface for previewing panorama imaging, according to an example embodiment.

FIG. 26 is a schematic illustration of an interface for pausing the preview of panorama imaging, according to an example embodiment.

FIG. 27 is a schematic illustration of an interface for panorama imaging, according to an example embodiment.

FIG. 28 is a schematic illustration of an interface for pausing the preview of panorama imaging, according to an example embodiment.

FIG. 29 is a schematic illustration of an interface for terminating the preview of panorama imaging, according to an example embodiment.

FIG. 30 is a schematic illustration of an initial interface for preview of pointing imaging, according to an example embodiment.

FIG. 31 is a schematic illustration of an interface for adding a point in pointing imaging, according to an example embodiment.

FIG. 32 is a schematic illustration of an interface for selecting a point in pointing imaging, according to an example embodiment.

FIG. 33 is a schematic illustration of an interface for imaging at a selected point, according to an example embodiment.

FIG. 34 is a schematic illustration of an interface for changing the selected point, according to an example embodiment.

FIG. 35 is a flow chart illustrating an imaging method, according to an example embodiment.

FIG. 36 is a schematic illustration of an interface for taking a photo, according to an example embodiment.

FIG. 37 is a schematic illustration of an imaging interface, according to another example embodiment.

FIG. 38 is a schematic illustration of an initial interface for video imaging, according to an example embodiment.

FIG. 39 is a schematic illustration of an interface while video imaging is in progress, according to an example embodiment.

FIG. 40 is a schematic diagram of a structure of an imaging control device, according to an example embodiment.

FIG. 41 is a schematic diagram of a structure of an imaging control device, according to another example embodiment.

FIG. 42 is a schematic diagram of a structure of a terminal device, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

The term “imaging” means capturing one or more images or frames of images (e.g., a video) using an image capturing device, such as a camera, a camcorder, or any suitable electronic device including a camera. The term “imaging” encompasses both photographing and video recording. Imaging may also include other non-conventional imaging, such as imaging based on infrared, radar, laser, x-ray, etc.

The term “click” as used in clicking a button or a graphic component on an interface, such as a computer-generated interface, should be interpreted broadly to encompass selection using all suitable means and through all suitable actions, such as pressing, single clicking, double clicking, tapping, swiping, touching, etc., through a user's finger, an input device such as a mouse, a keyboard, a touch pad, a touch screen, an electronic pen (e.g., a stylus), etc.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “I” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following embodiments do not limit the sequence of execution of the steps included in the disclosed methods. The sequence of the steps may be any suitable sequence, and certain steps may be repeated.

The technical solutions of the present disclosure will be described and explained in detail with reference to the accompanying drawings.

The present disclosure provides an imaging control method and device, which can improve imaging efficiency and flexibility.

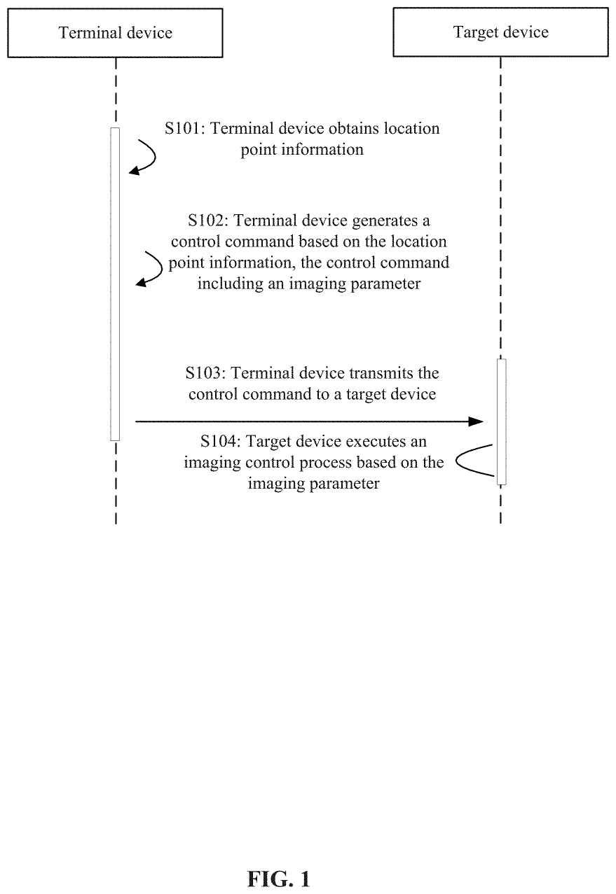

FIG. 1 is an interactive diagram showing an imaging method. The method includes the following steps.

S101: obtaining location point information by a terminal device.

In the present disclosure, a terminal device may obtain the location point information. The location point information may be determined based on angle data. The angle data may be determined based on values of directional angles of a target device. The values of directional angles may include at least one of a pitch angle, a yaw angle, or a roll angle.

S102: generating a control command by the terminal device based on the location point information. The control command carries or includes imaging parameters.

In the present disclosure, the terminal device may generate the control command that includes the imaging parameters based on the location point information.

S103: transmitting, by the terminal device, the control command to the target device.

In the present disclosure, the terminal device may transmit the control command to the target device.

S104: executing, by the target device, an imaging control process based on the imaging parameters.

In the present disclosure, the target device may execute the imaging control process based on the imaging parameters included in the control command.

In some embodiments, the terminal device may generate an imaging route based on angle data corresponding to the location point information of at least two location points, and generate the control command based on the imaging route. The control command may be used to control the target device to execute an imaging control process based on the imaging route. The target device may include at least one of a gimbal or an image capturing device.

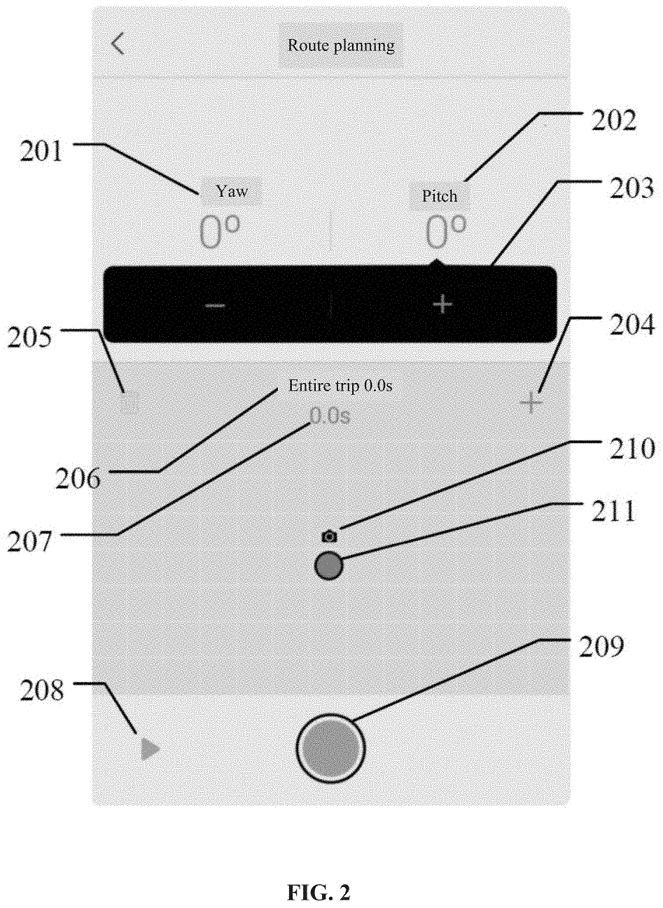

In some embodiments, the terminal device may obtain a selected command. The selected command may be used to select a target location point based on the location point information. The terminal device may generate the control command corresponding to the imaging route based on the selected target location point. The control command may be used to control the target device to move to the selected target location point. The detailed processes are explained in FIG. 2. FIG. 2 is a schematic illustration of an initial interface for route imaging (e.g., imaging along a preconfigured route). As shown in FIG. 2, the initial control interface for route imaging shown on the terminal device may include: translation 201, which may refer to the yaw angle; pitching 202, which may refer to the pitch angle; adjusting bar 203, which may be operated to adjust an angle value of the yaw angle 201 or the pitch angle 202. Reference numeral 204 is a “+” sign, which is an “add” button for adding a location point. Reference numeral 205 is a delete button for deleting a location point (delete button 205). Reference numeral 206 is the time required to shoot along the whole preconfigured route. Reference numeral 207 is the time that has been used during shooting or photographing. Reference numeral 208 is a preview button (preview button 208), reference numeral 209 is an imaging button (imaging button 209), reference numeral 210 indicates the current location of the target device (current location 210), and reference numeral 211 indicates a selected initial location point (initial location point 211).

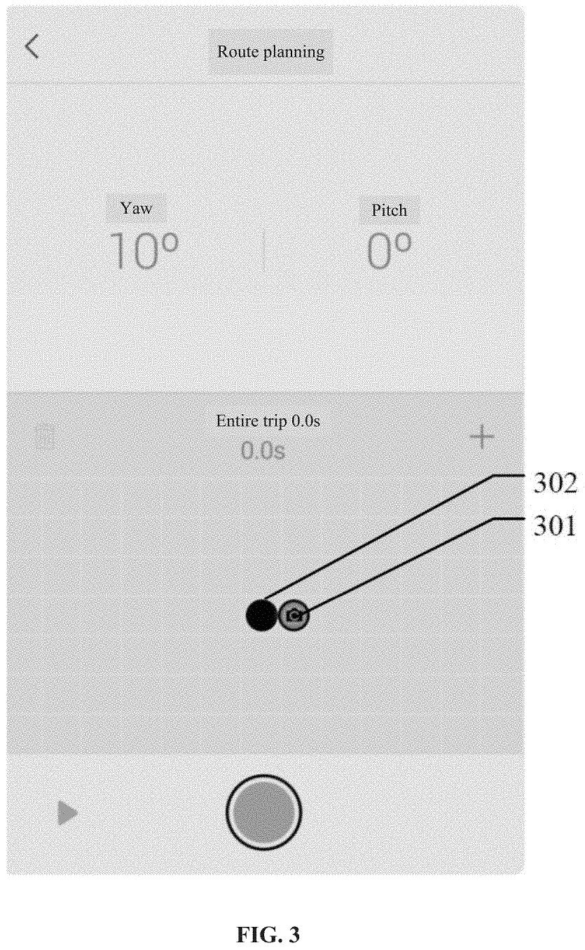

In some embodiments, when the user clicks the initial location point 211, and clicks the add button 204, the terminal device may add a new location point and output the control interface displayed on the terminal device. For example, FIG. 3 is a schematic illustration of an interface for adding a point in route imaging. The added new location point is indicated by reference numeral 301 (location point 301), as shown in FIG. 3. When the user clicks to select the location point 301, the terminal device may obtain a selection command. The selection command may be configured to control a gimbal of the target device to move from a location point 302 to a target location point 301. If the user again clicks the add button 204 shown in

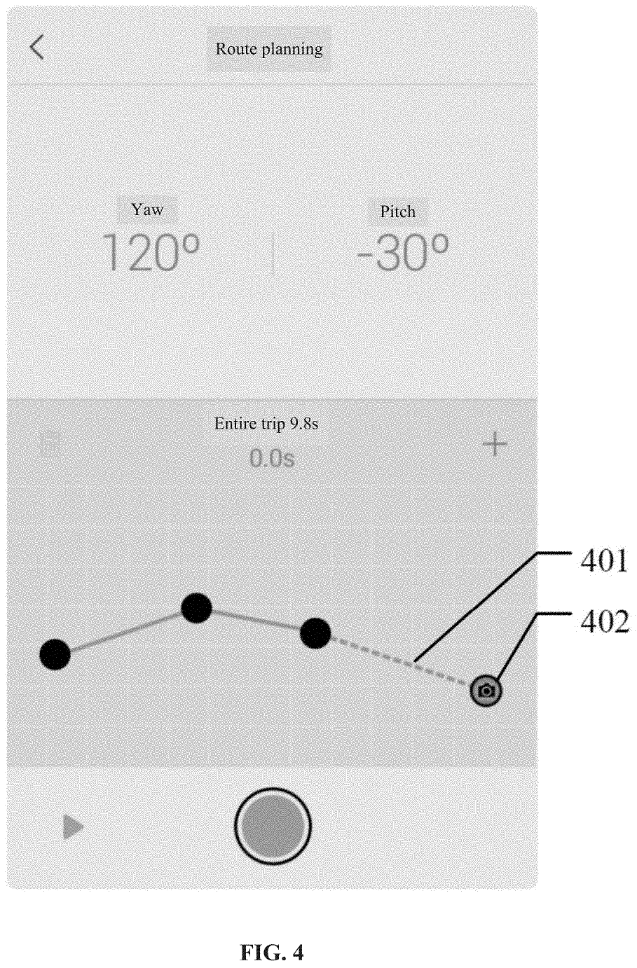

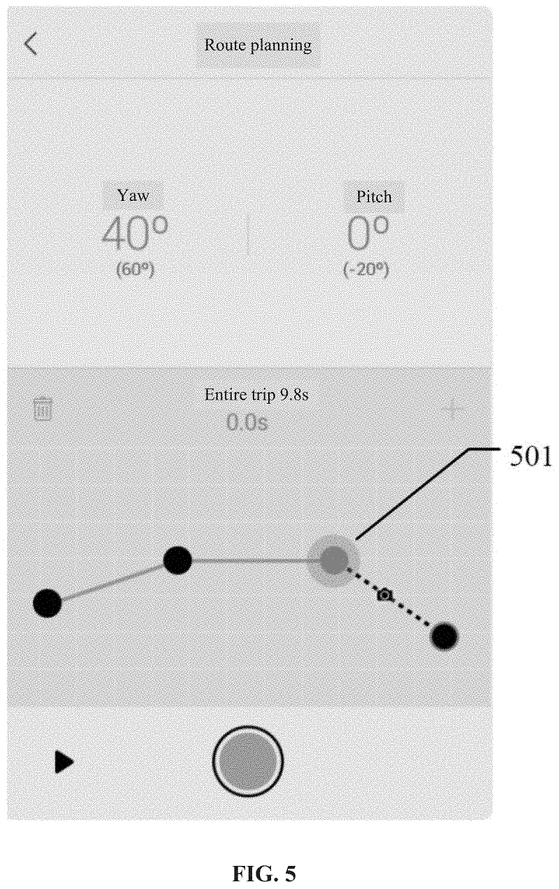

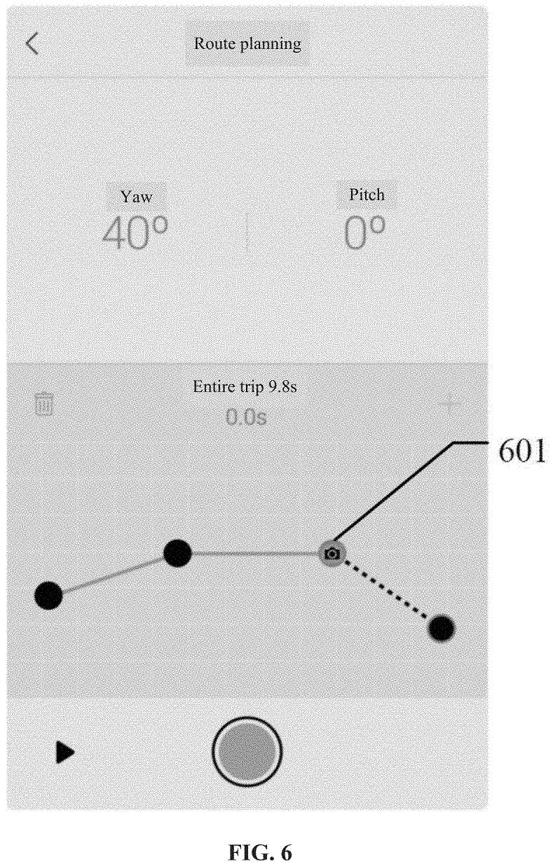

FIG. 2, the terminal device may add a new location point at the selected target location point 301 shown in FIG. 3, and may display the newly added location point on the control interface of the terminal device. In similar fashions, the user may add multiple location points. FIG. 4 is a schematic illustration of an interface for adding multiple points in route imaging. The ellipsis 401 indicates that multiple location points may exit and are omitted in the display of the interface. Reference numeral 402 indicates a selected target location point. When the user clicks and select another location point, this situation may be explained with reference to FIG. 5. FIG. 5 is a schematic illustration of an interface showing a target device following a selected point. For example, when the target device is at the location point 402 shown in FIG. 4, and when the user clicks to select a location point 501 shown in FIG. 5, the terminal device may obtain a selection command, and may transmit the selection command to the gimbal of the target device, such that the gimbal of the target device may move or be moved from the location point 402 shown in FIG. 4 to the location point 501 shown in FIG. 5. The terminal device may display the moving process of the gimbal of the target device on the control interface of the terminal device. When the gimbal of the target device arrives at the selected point, the terminal device may output an interface as shown in FIG. 6. FIG. 6 is a schematic illustration of an interface showing the target device arriving at a location of the selected point. Reference numeral 601 indicates an angle of location of the selected point to which the gimbal of the target device has moved.

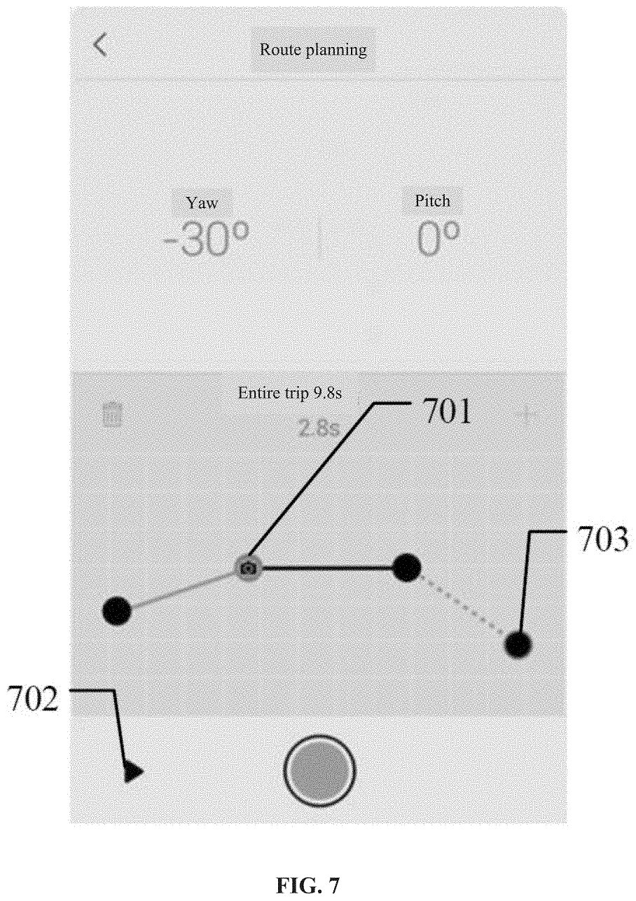

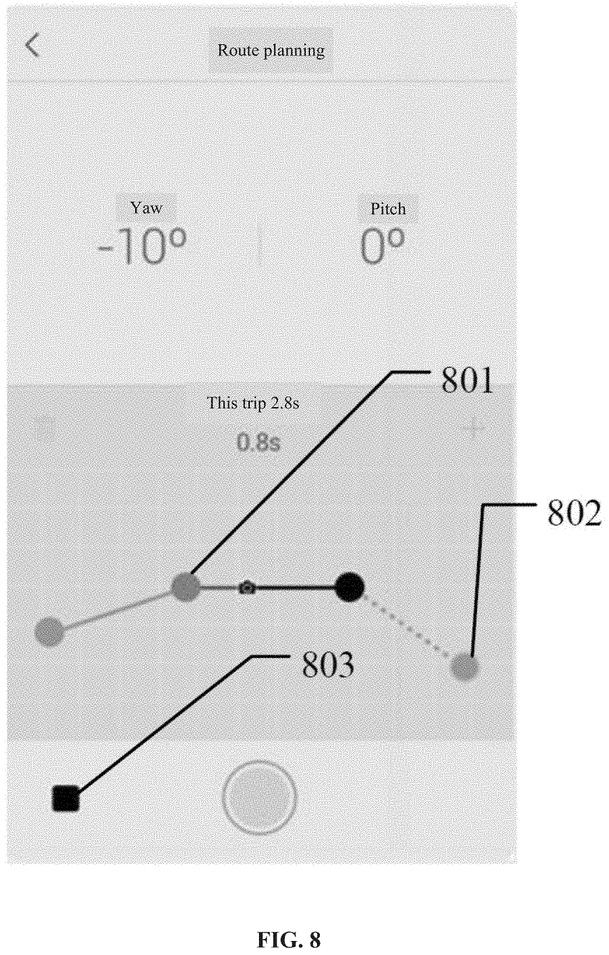

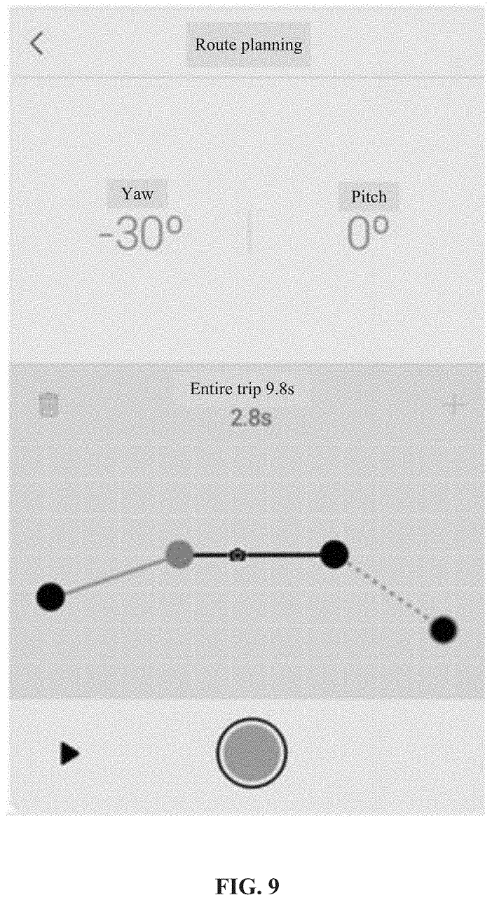

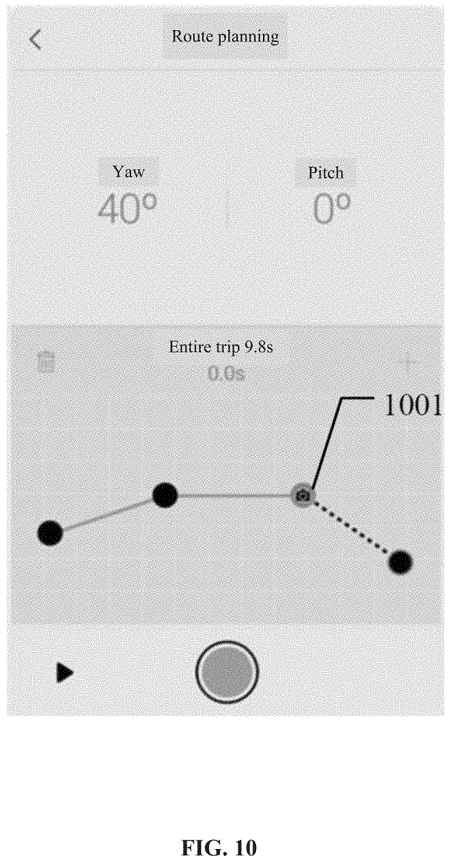

In some embodiments, the terminal device may obtain a preview command. The preview command may include one or more of a preview starting command, a preview pausing command, or a preview terminating command. The terminal device may generate a control command for the imaging route based on the preview command. FIG. 7 is a schematic illustration of an interface for previewing the selected specific point in route imaging. As shown in FIG. 7, the imaging route is formed by various location points. If the user selects a location point 701 as shown in FIG. 7, then clicks a preview button 702, the terminal device may obtain the preview command and transmit the preview command to the target device. The preview command may be configured to control the target device to preview from the selected point 701 to the location 703 based on the imaging route. In some embodiments, the preview command obtained by the terminal device may not include an imaging command. After the terminal device obtains the preview starting command, the terminal device may transmit the preview starting command to the target device, such that the target device to move from the selected location point, along the imaging route, to the last location point in the imaging route, as shown in FIG. 8. FIG. 8 is a schematic illustration of an interface for previewing from a specific point to a next point in route imaging. When the terminal device obtains a command enabling preview from a selected point 801 to a location point 802 along the imaging route, the terminal device may transmit the command to the target device, such that the target device may move from the selected location point 801, along the imaging route, to the last location point 802 in the imaging route. If the user clicks the preview button 803 during the preview, the terminal device may obtain a preview pausing command. The terminal device may transmit the preview pausing command to the target device, such that the target device may pause the preview at the current location point. The terminal device may output and display the control interface shown in FIG. 9. FIG. 9 is a schematic illustration of an interface for pausing the preview in route imaging. If the terminal device obtains a preview terminating command at a location point 1001, the terminal device may output and display the control interface shown in FIG. 10. FIG. 10 is a schematic illustration of an interface for terminating the preview in route imaging.

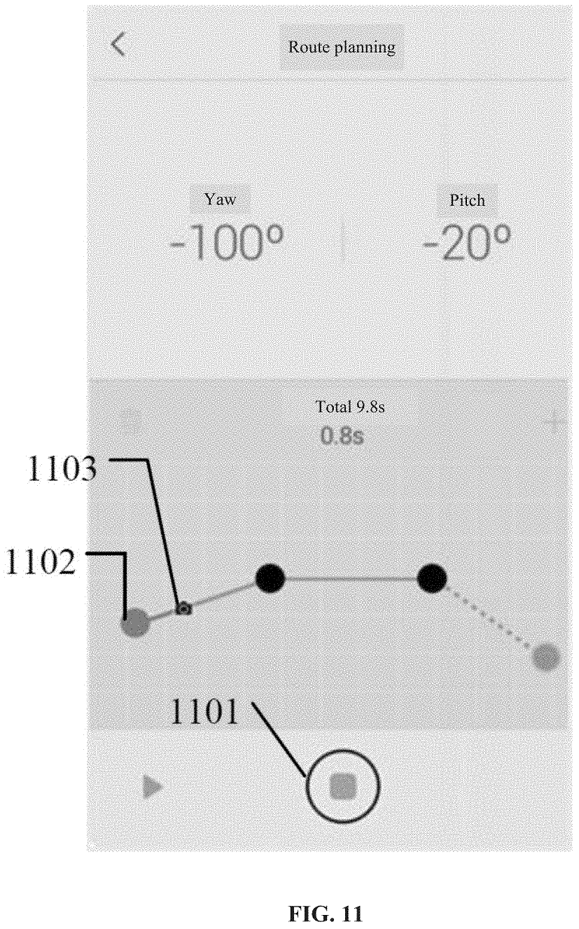

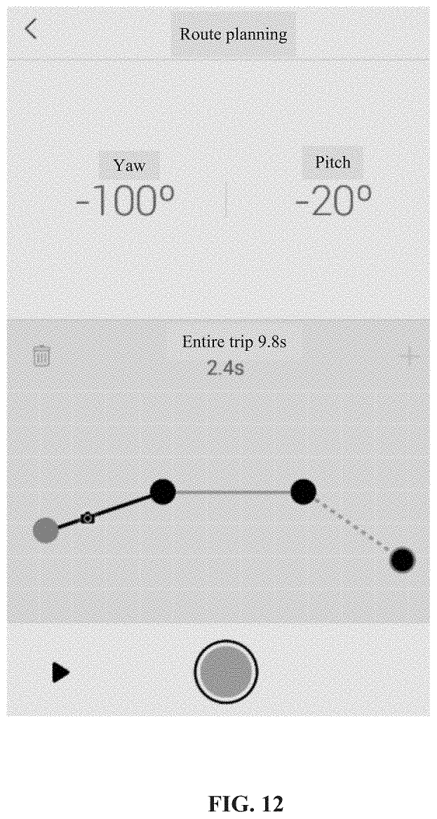

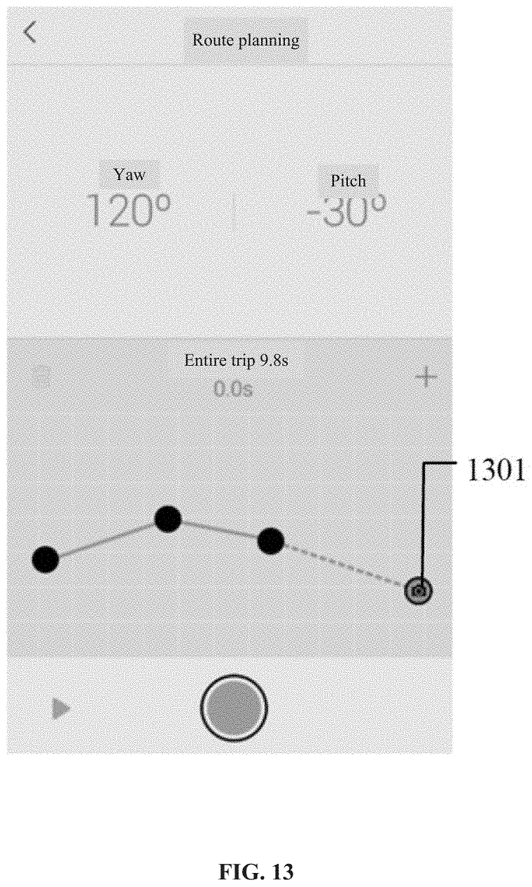

In some embodiments, the terminal device may obtain an imaging command. The imaging command may include one or more of an imaging starting command, an imaging pausing command, or an imaging terminating command. The terminal device may generate a control command for the corresponding imaging route based on the imaging command. Referring to FIG. 11, FIG. 12, and FIG. 13, FIG. 11 is a schematic illustration of an interface for route imaging. When a user clicks an imaging button 1101, the terminal device may obtain an imaging starting command, and may transmit the imaging starting command to the target device, such that the target device may start imaging from the first location point 1102 on the imaging route. When the target device moves to a location 1103 while imaging, if the user clicks the imaging pausing button 1101, the terminal device may obtain an imaging pausing command, and transmit the imaging pausing command to the target device. The target device may pause the imaging operation at the location point 1103, and output and display the control interface shown in FIG. 12. FIG. 12 is a schematic illustration of an interface for pausing the route imaging. When the user clicks the imaging button, the terminal device may obtain an imaging starting command. The imaging starting command may instruct the target device to continue imaging starting from the location point 1201. If the terminal device obtains an imaging terminating command, the terminal device may output and display a control interface as shown in FIG. 13. FIG. 13 is an interface for terminating the imaging, at which time the target device arrives at the last location point 1301 in the imaging route.

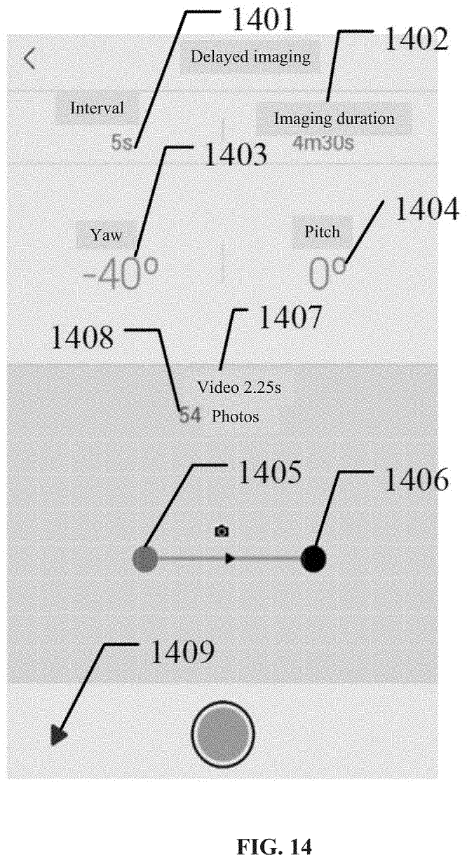

In some embodiments, the terminal device may obtain one or more imaging parameters while imaging between at least two location points. The imaging parameters may include one or more of an imaging time interval parameter, an imaging time duration parameter, an imaging angle parameter, an imaging quantity parameter, or a playback time parameter. The terminal device may generate a control command based on the one or more imaging parameters. The control command may be configured to control the target device to execute an imaging control process based on the one or more imaging parameters. For example, FIG. 14 is a schematic illustration of an initial interface for delayed imaging. As shown in FIG. 14, reference numeral 1401 is an imaging time interval parameter, reference numeral 1402 is an imaging time duration parameter. Reference numerals 1403 and 1404 are imaging angle parameters including the yaw angle and the pitch angle, respectively. Reference numeral 1408 is an imaging quantity parameter, and reference numeral 1407 is a playback time parameter.

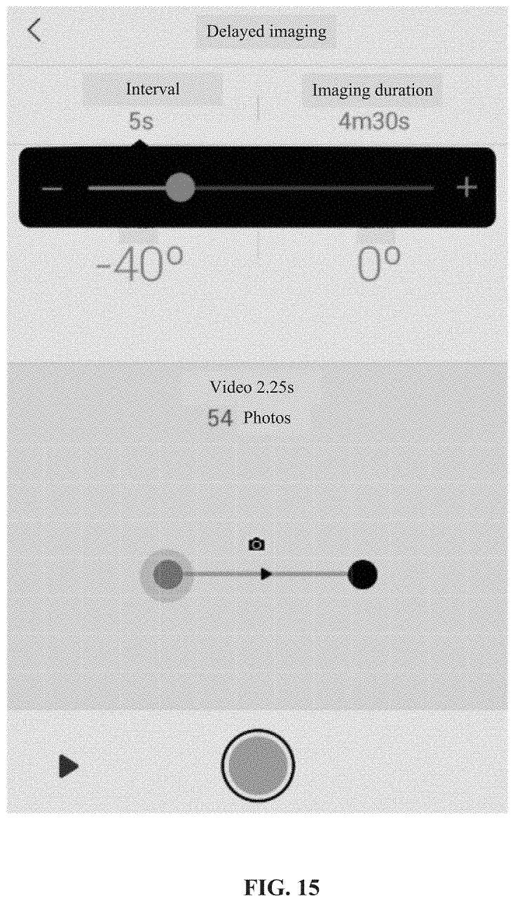

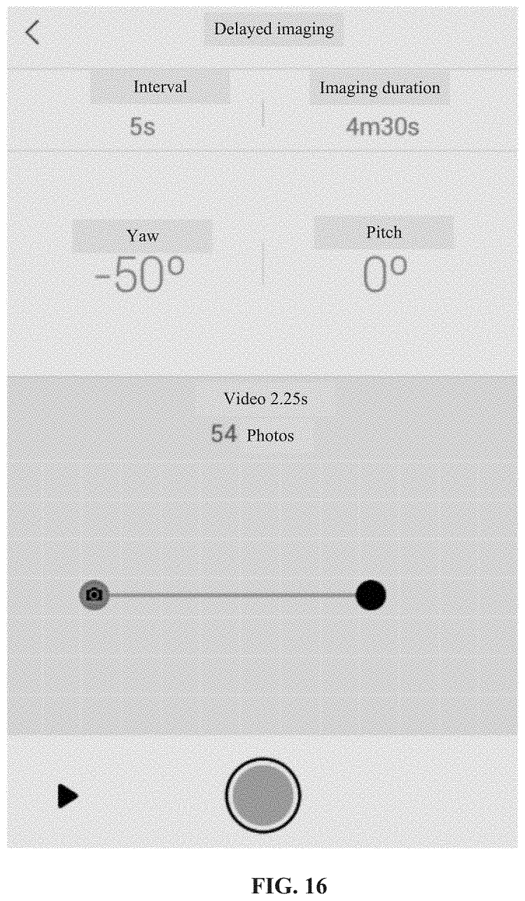

In some embodiments, the terminal device may obtain imaging adjustment information. The imaging adjustment information may include one or more of: adjustment information for the imaging time interval parameter, adjustment information for the imaging time duration parameter, adjustment information for the imaging angle parameter, adjustment information for the imaging quantity parameter, or adjustment information for the playback time parameter. The terminal device may generate a control command based on the imaging adjustment information. The control command may be configured to control the target device to execute an imaging control process based on the imaging parameters. FIG. 15 is a schematic illustration of an interface for adjusting parameters for delayed imaging. As shown in FIG. 14 and FIG. 15, the user may adjust the imaging time interval parameter 1401 to be 5s, the imaging time duration parameter 1402 to be 2 m30 s. The user may obtain the imaging quantity parameter 1408 to be 54 photos, and the playback time parameter 1407 to be 2.25 s. The playback time parameter may be a playback time parameter for video editing. The terminal device may adjust the location point 1405 and location point 1406. By adjusting these two location points, the terminal device may output the interface shown in FIG. 16. FIG. 16 is an interface for adjusting location points for delayed imaging.

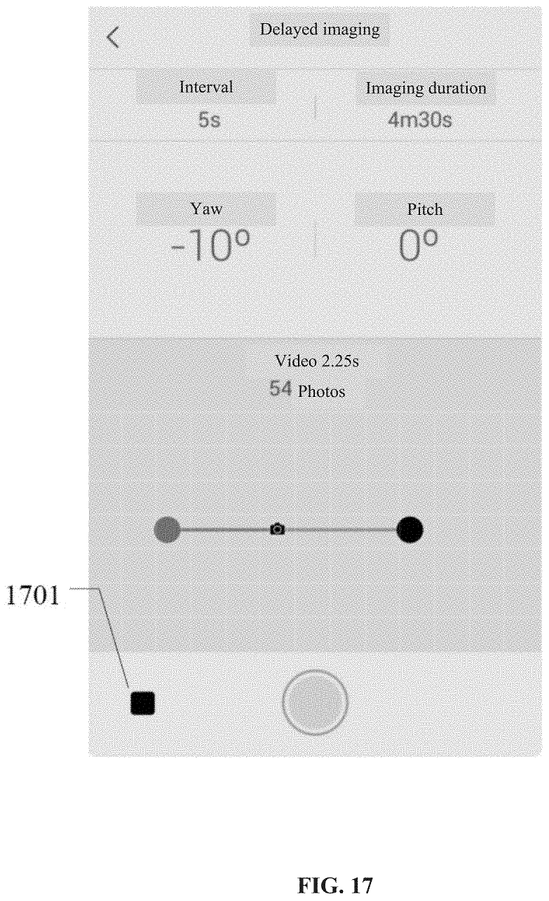

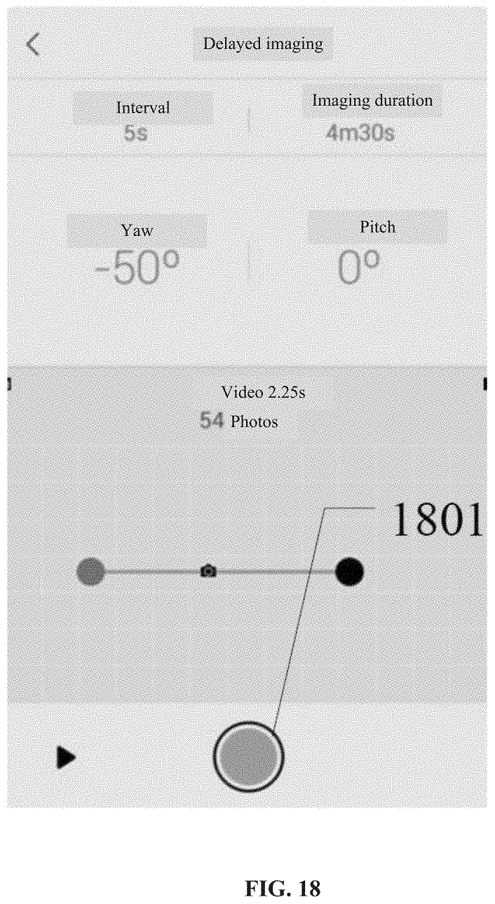

In some embodiments, the terminal device may obtain a preview command. The preview command may include one or more of a preview starting command, a preview pausing command, or a preview terminating command. The terminal device may generate a control command corresponding to the imaging parameters based on the preview command. FIG. 17 is a schematic illustration of an interface for preview in the delayed imaging. When a user clicks the preview button 1409 shown in FIG. 14, the terminal device may obtain the preview command and transmit the preview command to the target device to cause the target device to form a route based on two location points and to preview. The terminal device may generate the control interface shown in FIG. 17. When the user clicks a pause button 1701 shown in FIG. 17, the terminal device may obtain a preview pausing command or a preview terminating command. The terminal device may output and display the control interface shown in FIG. 18. FIG. 18 is a schematic illustration of an interface for pausing preview or terminating preview in delayed imaging.

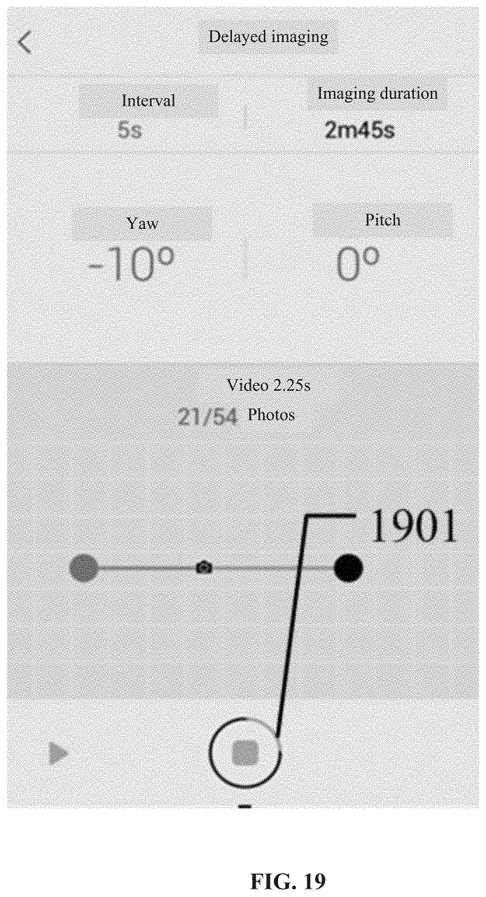

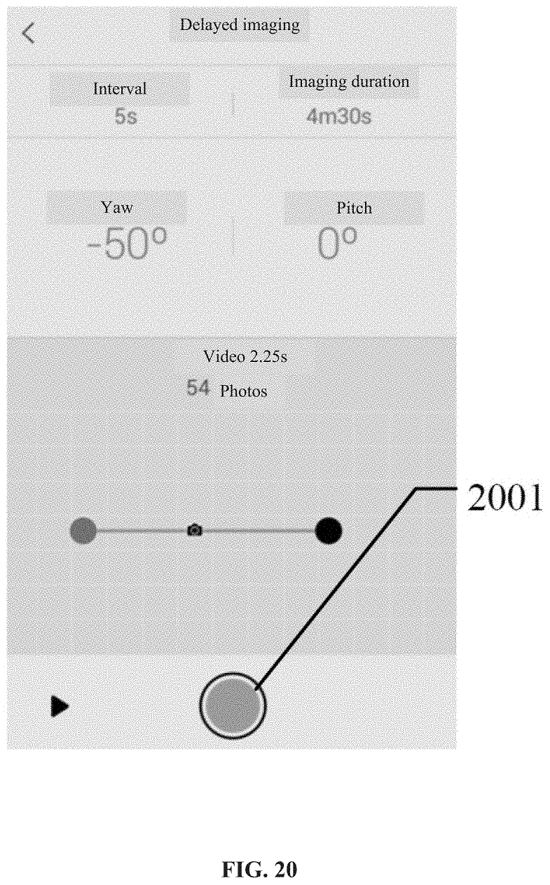

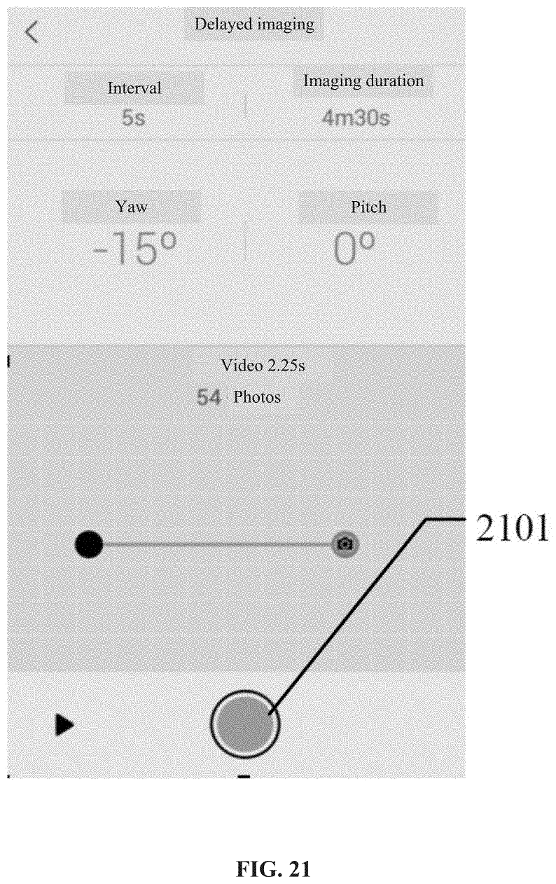

In some embodiments, the terminal device may obtain an imaging command. The imaging command may include one or more of an imaging starting command, an imaging pausing command, or an imaging terminating command. The terminal device may generate a control command corresponding to the imaging parameters based on the imaging command. Referring to FIG. 19, FIG. 20, and FIG. 21, when the user clicks an imaging button 1801 shown in FIG. 18, the terminal device may obtain an imaging command, and transmit the imaging command to the target device, such that the target device may execute delayed imaging operations based on the imaging parameters. The terminal device may generate the control interface shown in FIG. 19. FIG. 19 is a schematic illustration of an interface for delayed imaging. When the user clicks an imaging pausing button 1901 shown in FIG. 19, the terminal device may obtain an imaging pausing command and transmit the imaging pausing command to the target device, such that the target device may stop at the current location point and pause the imaging operations, as shown in FIG. 20. FIG. 20 is a schematic illustration of an interface for pausing the imaging in delayed imaging. When the user clicks an imaging button 2001 shown in FIG. 20, the terminal device may obtain an imaging command and transmit the imaging command to the target device, such that the target device may continue to execute delayed imaging along the imaging route starting from the current location point, until the target device arrives at a desired location point and terminates the imaging. FIG. 21 is a schematic illustration of an interface for terminating the delayed imaging. Reference numeral 2101 is an imaging button.

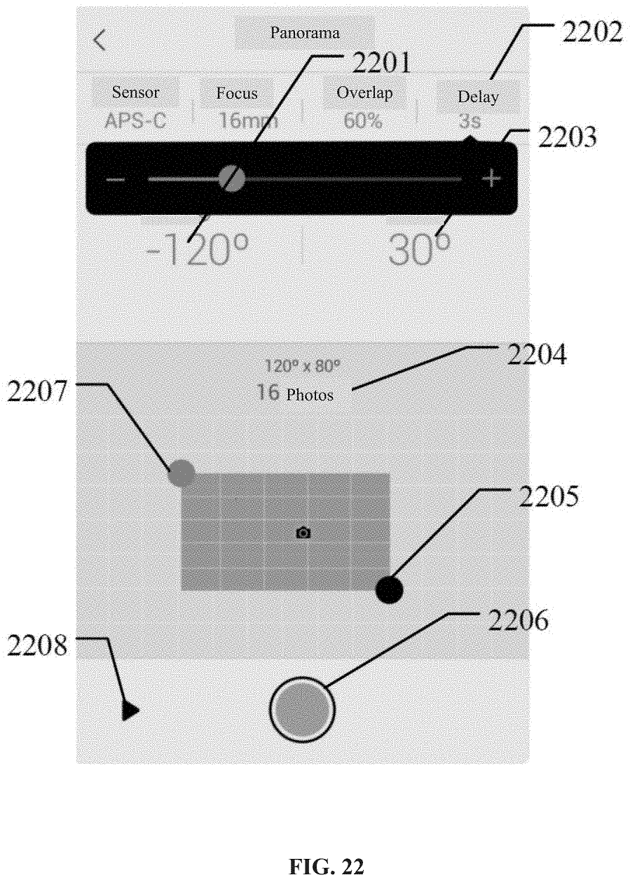

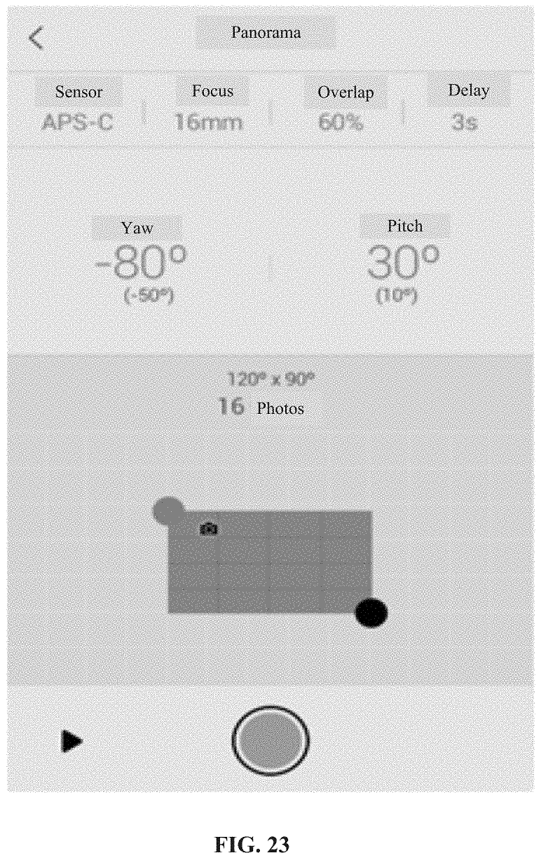

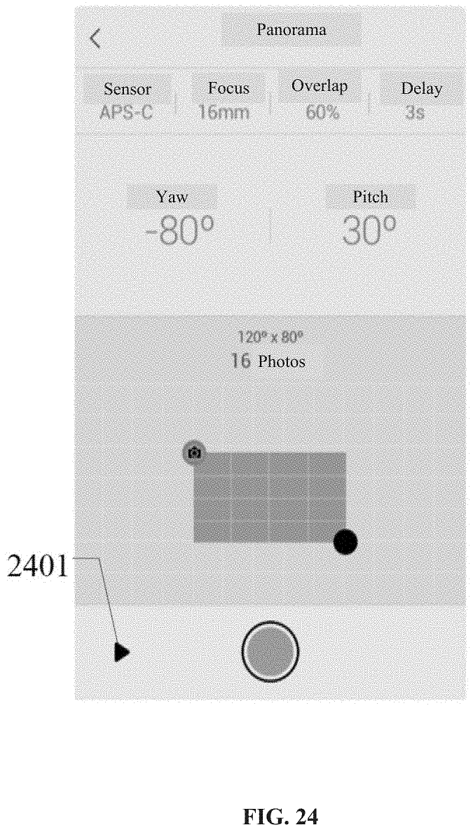

In some embodiments, the terminal device may obtain one or more imaging parameters based on at least two location points. The one or more imaging parameters may include one or more of a time interval parameter for panorama imaging, an angle location parameter for panorama imaging, an imaging scope parameter for panorama imaging, or an imaging quantity (e.g., including a photo quantity) parameter for panorama imaging. The terminal device may generate a control command based on the one or more imaging parameters. The control command may be configured to control the target device to execute an imaging control process based on the one or more imaging parameters. FIG. 22 is a schematic illustration of an initial interface for panorama imaging. As shown in FIG. 22, reference numeral 2202 is the time interval parameter for panorama imaging, reference numeral 2201 is the yaw angle location parameter for panorama imaging, reference numeral 2203 is the pitch angle location parameter for panorama imaging, two location points 2205 and 2207 define the imaging scope parameter for panorama imaging, reference numeral 2204 is the imaging quantity (e.g., photo quantity) parameter for panorama imaging, reference numeral 2206 is an imaging button, and reference numeral 2208 is a preview button. When the user selects the location point 2207, the user may obtain a selection command and transmit the selection command to the gimbal of the target device, such that the gimbal of the target device may move to the location point 2207, as shown in FIG. 23. FIG. 23 is a schematic illustration of an interface showing following a selected point in panorama imaging. When the target device arrives at the selected location point 2207, as shown in FIG. 22, the terminal device may output the control interface shown in FIG. 24. FIG. 24 is a schematic illustration of an interface showing arriving at the selected point in panorama imaging.

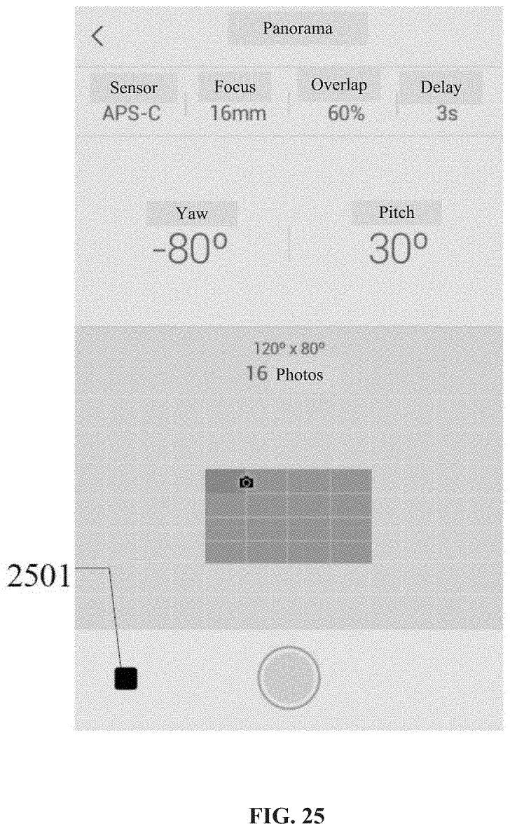

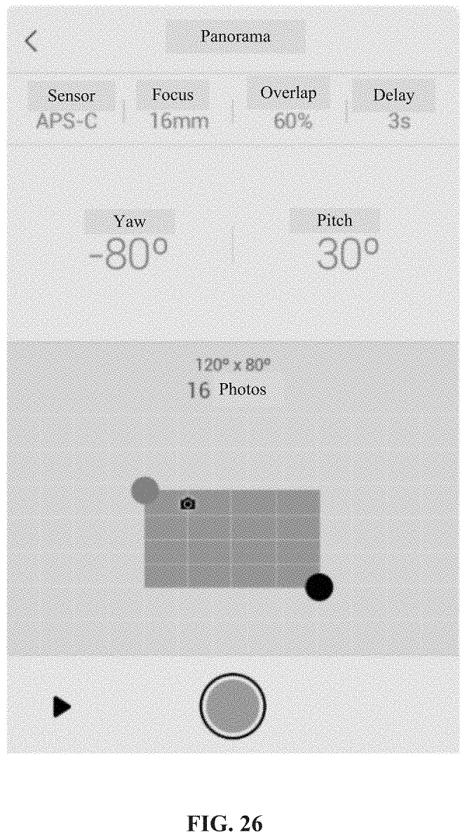

In some embodiments, the terminal device may obtain a preview command. The preview command may include one or more of a preview starting command, a preview pausing command, or a preview terminating command. The preview command may generate a control command corresponding to the one or more imaging parameters. When the user clicks a preview button 2401 shown in FIG. 24, the terminal device may obtain the preview command and transmit the preview command to the target device, such that the target device may execute preview operations based on the one or more imaging parameters. FIG. 25 is a schematic illustration of an interface for preview in the panorama imaging. When the user clicks a preview pausing button 2501 shown in FIG. 25, the terminal device may obtain the preview pausing command and transmit the preview pausing command to the target device, such that the target device may pause preview operations at the current location. The terminal device may output the control interface shown in FIG. 26. FIG. 26 is a schematic illustration of an interface for pausing preview in panorama imaging.

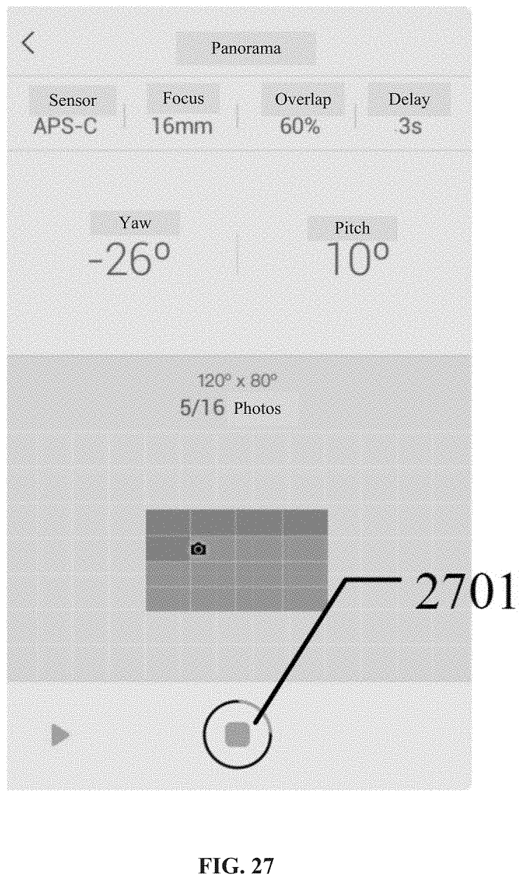

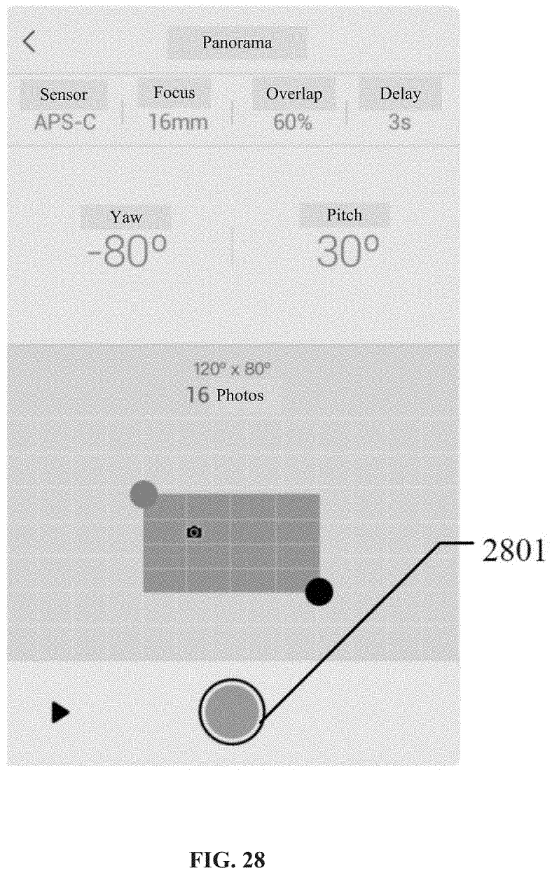

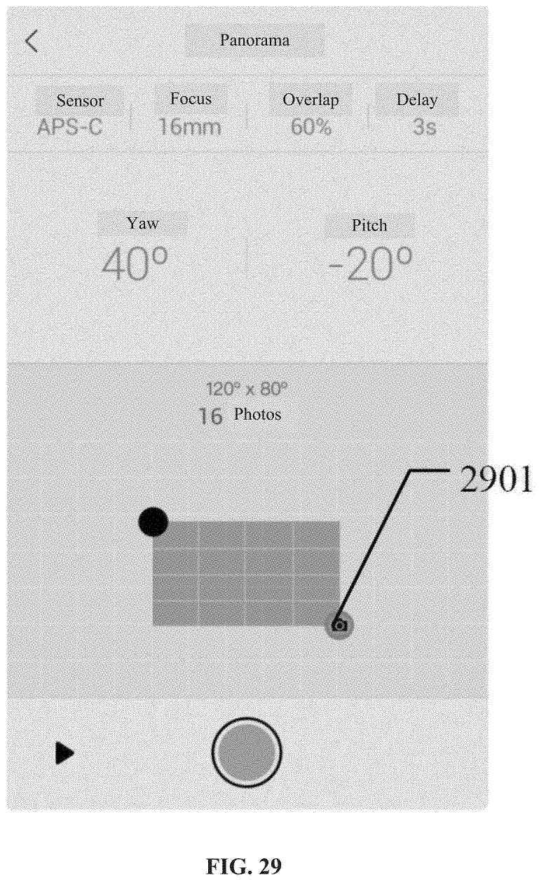

In some embodiments, the terminal device may obtain an imaging command. The imaging command may include one or more of an imaging starting command, an imaging pausing command, or an imaging terminating command. The terminal device may generate a control command corresponding to the one or more imaging parameters based on the imaging command. When the user selects the location point 2207 shown in FIG. 22, and clicks the imaging button 2206, the terminal device may obtain the imaging starting command and transmit the imaging starting command to the target device, such that the target device may execute panorama imaging operations within a pre-set imaging scope and based on pre-set imaging scope parameters and directions, as shown in FIG. 27. FIG. 27 is a schematic illustration of an interface for panorama imaging. When the user clicks an imaging pausing button 2701, the terminal device may obtain an imaging pausing command and transmit the imaging pausing command to the gimbal and an imaging device of the target device, such that the gimbal and imaging device of the target device may pause executing control operations for panorama imaging at the current location point. The terminal device may output the control interface shown in FIG. 28. FIG. 28 is a schematic illustration of an interface for pausing imaging in panorama imaging. When the user clicks an imaging button 2801 shown in FIG. 28, the terminal device may obtain the imaging starting command and transmit the imaging starting command to the gimbal and imaging device of the target device, such that the gimbal of the target device may move based on the imaging scope parameter, and the imaging device may execute imaging operations. When the gimbal of the target device moves to a location point 2901 shown in FIG. 29, the terminal device may obtain an imaging terminating command. The terminal device may transmit the imaging terminating command to the target device, such that the gimbal of the target device may stop moving and the imaging device may terminate imaging. FIG. 29 is a schematic illustration of an interface for terminating panorama imaging.

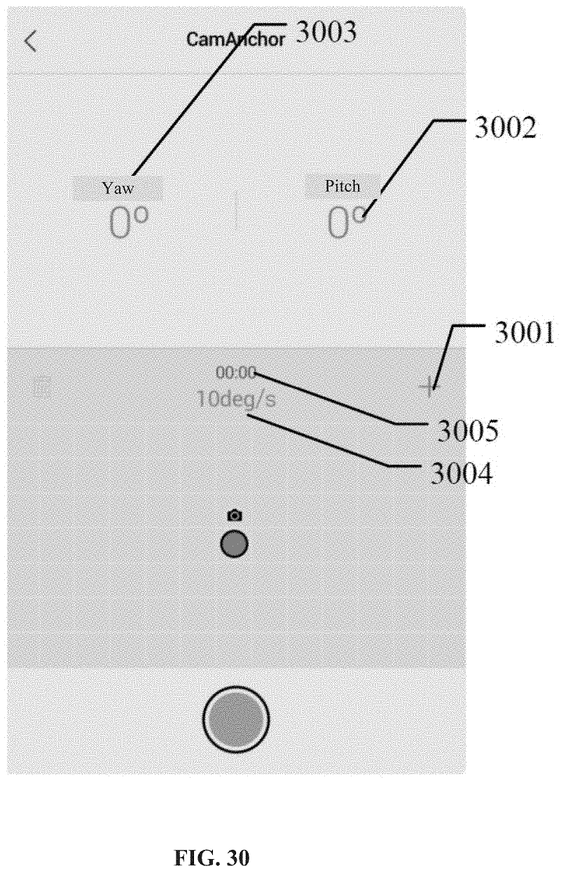

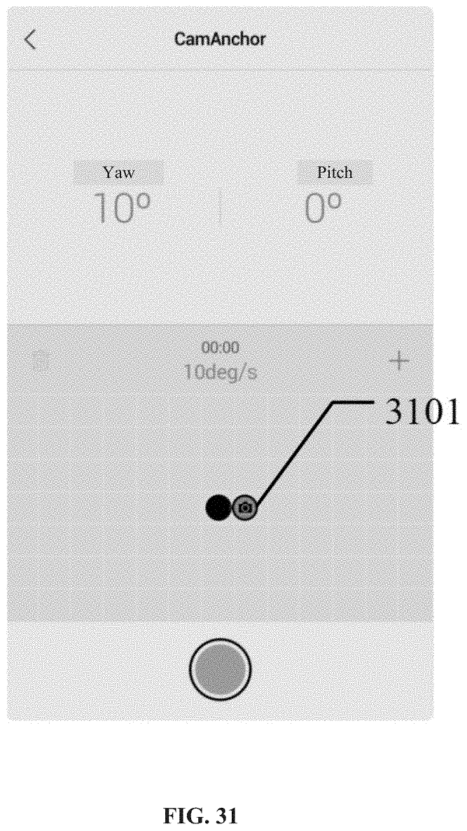

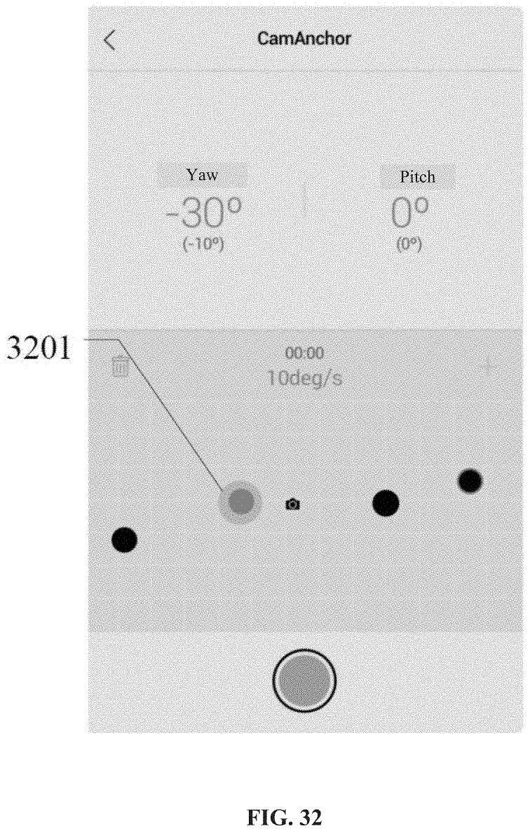

In some embodiments, the terminal device may obtain one or more imaging parameters at at least two location points. The one or more imaging parameters may include one or more of a location point adding parameter, an imaging angle parameter, an imaging time duration parameter, or an imaging speed parameter. The terminal device may generate a control command based on the one or more imaging parameters. The control command may be configured to control the target device to execute an imaging control process based on the one or more imaging parameters. In some embodiments, the terminal device may obtain an adding command. The adding command may be configured to add a new location point at a selected target location point. The terminal device may generate a control command corresponding to the one or more imaging parameters based on the adding command. The control command may be configured to control the target device to execute an imaging control process at the selected target location point. FIG. 30 is schematic illustration of an initial interface for pointing imaging. Reference numeral 3001 is a location point adding button, reference numeral 3002 is a yaw imaging angle parameter, reference numeral 3003 is a pitch imaging angle parameter, reference numeral 3005 is an imaging time duration parameter, and reference numeral 3004 is an imaging speed parameter. When the user clicks the location point adding button 3001, the terminal device may obtain the adding command. The adding command may be configured to add a new location point at a selected target location point. FIG. 31 is a schematic illustration of an interface for adding a point in pointing imaging. The location 3101 is a new location point added. The terminal device may add multiple location points. The user may select one of the location points, as shown in FIG. 32. FIG. 32 is a schematic illustration of an interface for selecting a point in pointing imaging. When the user selects the location point 3201, the terminal device may obtain the selection command and may transmit the selection command to the gimbal of the target device, such that the gimbal may move from the current location to the selected location point 3201.

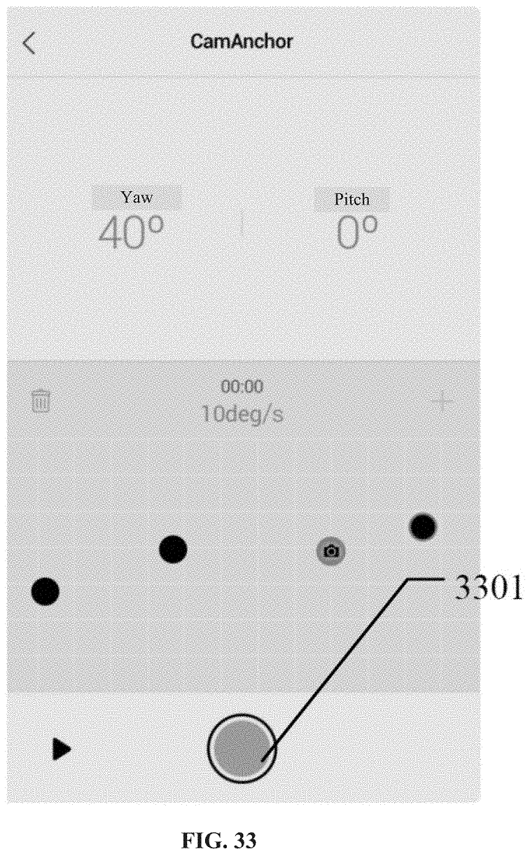

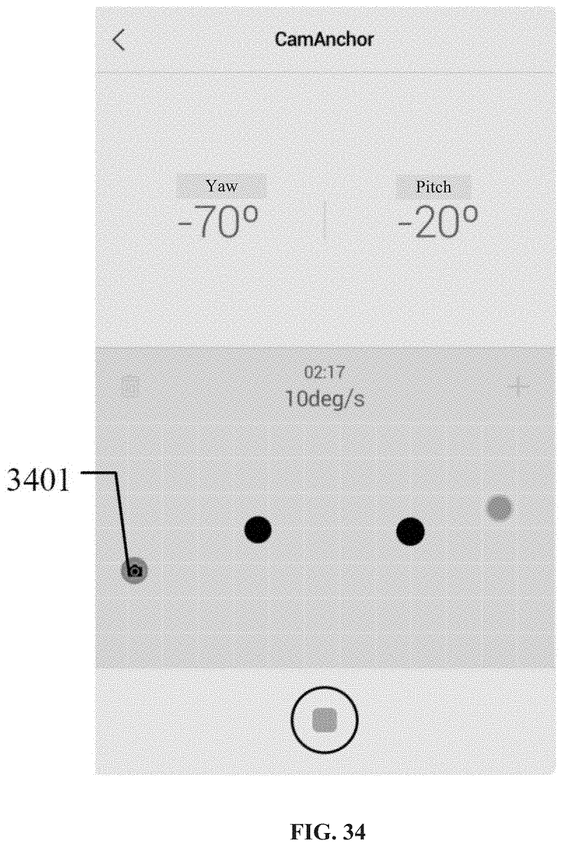

In some embodiments, the terminal device may obtain an imaging command. The imaging command may include one or more of an imaging starting command, a changing target location imaging command, or an imaging terminating command. The terminal device may generate a control command corresponding to the one or more imaging parameters based on the imaging command. The control command may be configured to control the target device to execute an imaging control process at the selected target location point. FIG. 33 is a schematic illustration of an interface for imaging at a selected point. When the user clicks an imaging button 3301 shown in FIG. 33, the terminal device may obtain the imaging command and transmit the imaging command to the target device, such that the imaging device of the target device may execute imaging operations. The user may click to select other location points. The terminal device may obtain a changing selected point command, as shown in FIG. 34. FIG. 34 is a schematic illustration of an interface for changing the selected point. The terminal device may transmit the changing selected point command to the gimbal of the target device, such that the gimbal may move to a changed selected point 3401.

In some embodiments, the terminal device may obtain location point information and generate a control command that includes one or more imaging parameters based on the location point information. The terminal device may transmit the control command to the target device. The target device may execute an imaging control process based on the one or more imaging parameters. As a result, the imaging control operations are realized, and the imaging efficiency and flexibility are improved.

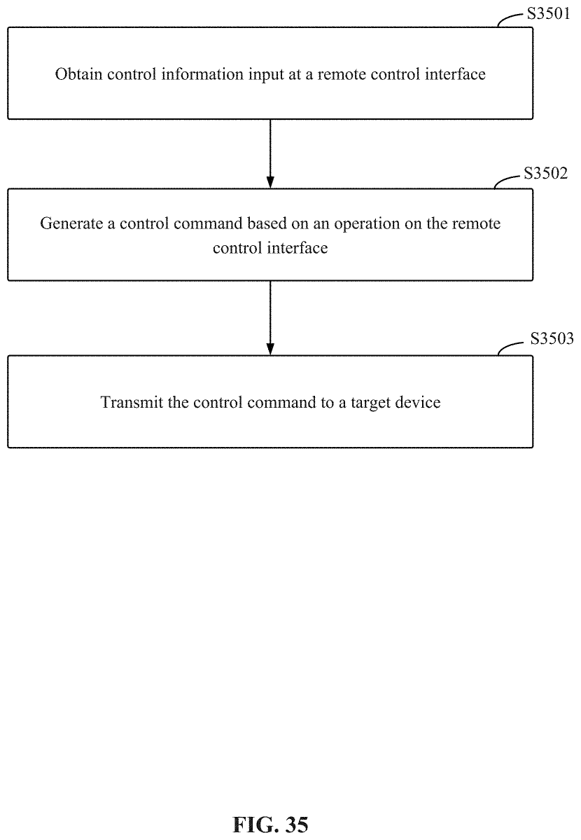

FIG. 35 is a flow chart illustrating an imaging method. The imaging method may include the following steps:

S3501: obtaining control information input in a remote control interface.

In some embodiments, the terminal device may obtain the control information input in a remote control interface. The remote control interface may include one or more of an angle button, a speed button, a remote control mode switch button, or an imaging mode switch button.

S3502: generating a control command based on operations on the remote control interface.

In some embodiments, the terminal device may generate a control command based on operations on the remote control interface. The control command may include one or more imaging parameters.

S3503: transmitting the control command to a target device.

In some embodiments, the terminal device may transmit the control command to the target device. The control command may be configured to control the target device to execute an imaging control process based on the one or more imaging parameters.

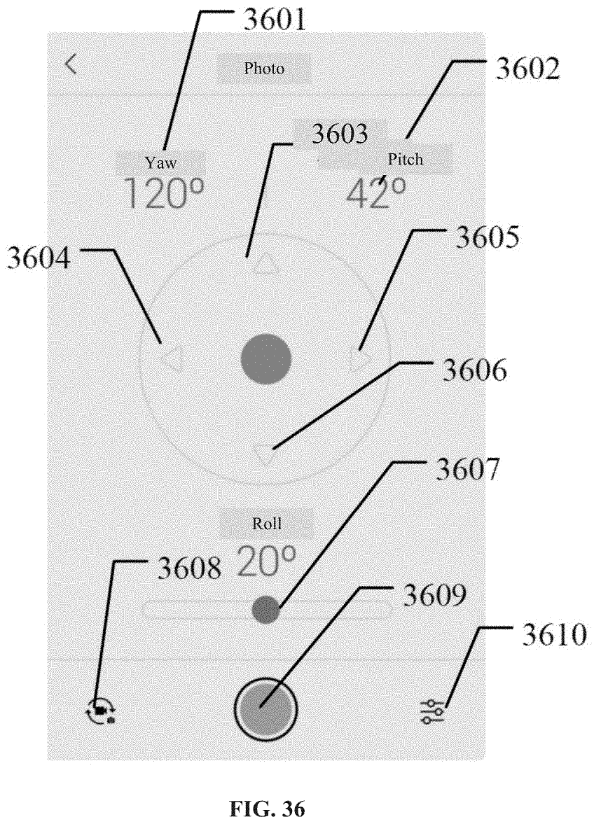

In some embodiments, when the remote control interface is in a first operating mode, the terminal device may generate an imaging angle parameter based on an operation by the user on an angle button included in the remote control interface. The terminal device may generate a control command based on the imaging angle parameter. The control command may be configured to control the target device to execute an imaging control process based on the imaging angle parameter. FIG. 36 is a schematic illustration of an interface for taking a photo. As shown in FIG. 36, the remote control interface is in the first operating mode. Angle buttons 3603 and 3606 may be operated to control a pitch angle 3602, angle buttons 3604 and 3605 may be operated to control a yaw angle 3601, and an angle button 3607 may be operated to control a roll angle. Reference numeral 3609 is an imaging button, and reference numeral 3608 is an imaging mode switching button for switching between a photo mode and a video mode, and reference numeral 3610 is a remote control mode switching button for switching between the first operating mode and a second operating mode.

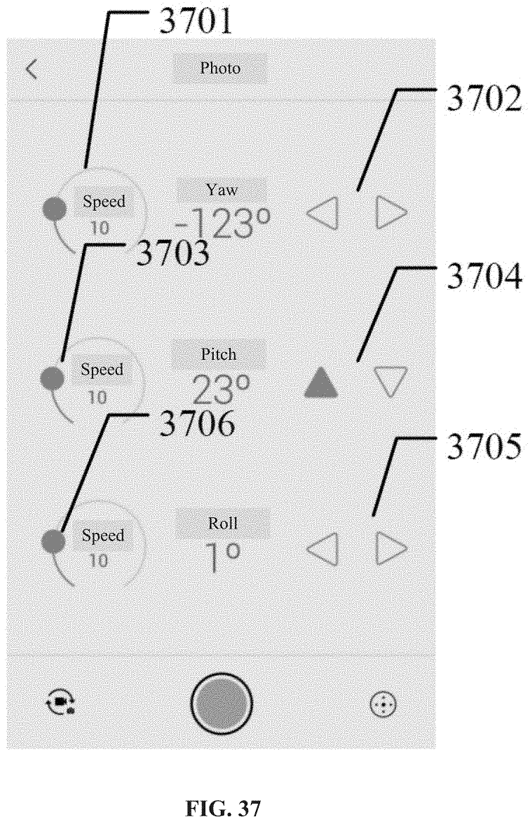

In some embodiments, the terminal device may obtain a user operation on a remote control mode switching button. The terminal device may generate a switch control command based on the user operation on the remote control mode switching button. The switch control command may be configured to control the target device to switch from the first operating mode to the second operating mode. When the user clicks the remote control mode switching button 3610, the terminal device may obtain a switching command. The switching command may be configured to switch the first operating mode to the second operating mode. FIG. 37 is a schematic illustration of another imaging interface. As shown in FIG. 37, the remote control interface is in the second operating mode. An angle button 3702 may control the yaw angle, the angle button 3704 may control the pitch angle, and the angle button 3705 may control the roll angle. A control knob 3701 may control a speed of the yaw angle, a control knob 3703 may control the speed of the pitch angle, and a control knob 3706 may control a speed of the roll angle. When the remote control interface is in the second operating mode, the terminal device may generate one or more imaging parameters based on user operations on one or more angle buttons and/or one or more speed knobs. The one or more imaging parameters may include at least one of an imaging angle parameter or an imaging speed parameter. The terminal device may generate a control command based on the imaging angle parameter. The control command may be configured to control the target device to execute an imaging control process based on the imaging angle parameter.

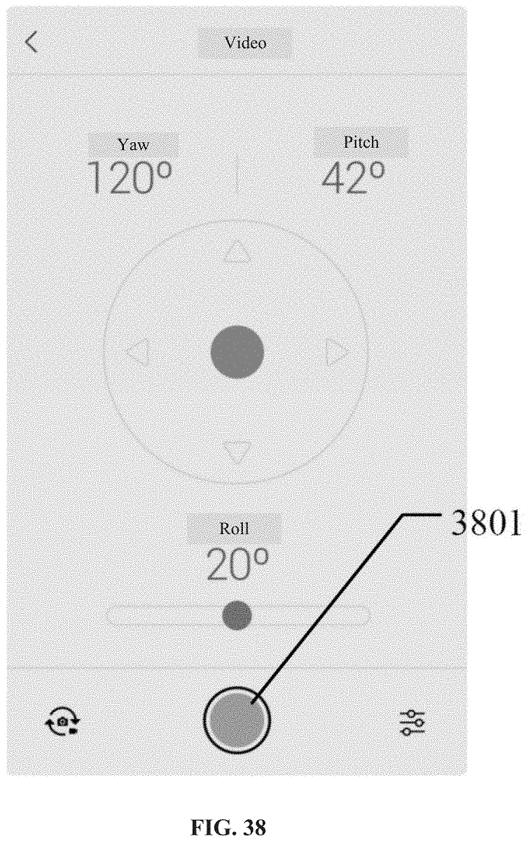

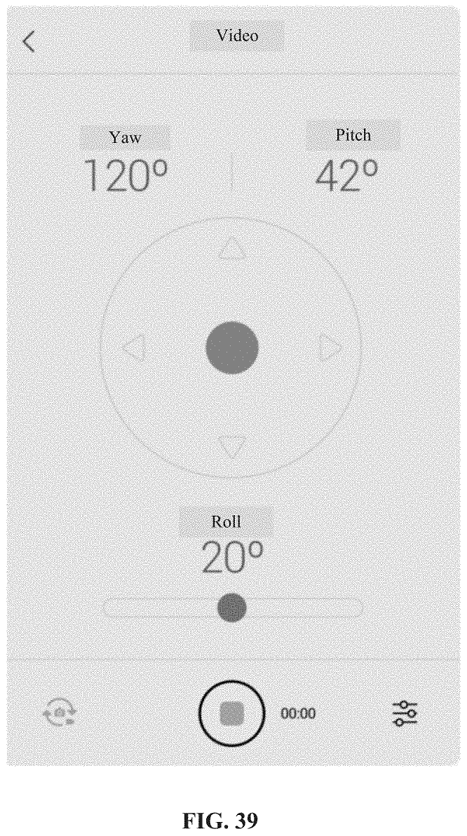

In some embodiments, the terminal device may obtain a user operation on the imaging mode switching button 3608 included in the remote control interface. The terminal device may generate a switching control command based on the user operation on the imaging mode switching button 3608. The switching control command may be configured to control the target device to execute the switching operations between the photo mode and the video mode. FIG. 38 is a schematic illustration of an initial interface for video imaging. When the user clicks an imaging button 3801 shown in FIG. 38, the terminal device may obtain an imaging command and transmit the imaging command to the imaging device of the target device, such that the imaging device may execute video imaging operations. The terminal device may output an interface showing the video imaging process, as shown in FIG. 39. FIG. 39 is a schematic illustration of an interface while the video imaging is in progress.

In some embodiments, the terminal device may obtain control information input from the remote control interface. The terminal device may generate a control command based on the operations on the remote control interface and transmit the control command to the target device. As a result, the imaging control operations are realized, and the imaging efficiency and flexibility are improved.

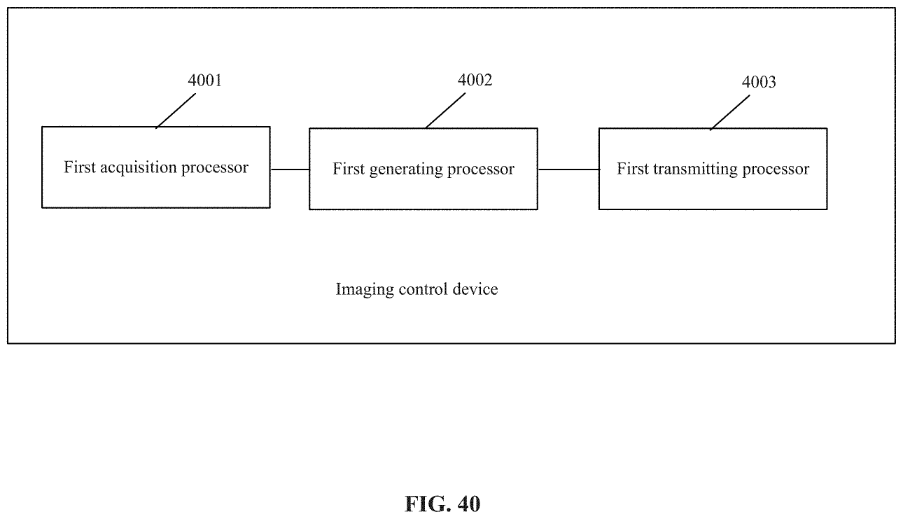

FIG. 40 is a schematic diagram of an imaging control device. The imaging control device may include a first acquiring processor 4001, a first generating processor 4002, and a first transmitting processor 4003.

The first acquiring processor 4001 may be configured to obtain location point information, which may be determined based on angle data.

The first generating processor 4002 may be configured to generate a control command based on the location point information. The control command may include one or more imaging parameters.

The first transmission processor 4003 may be configured to transmit the control command to a target device. The control command may be configured to control the target device to execute an imaging control process based on the one or more imaging parameters.

In some embodiments, the first generating processor 4002 may be configured to generate an imaging route based on angle date corresponding to location point information of at least two location points. The first generating processor 4002 may generate a control command based on the imaging route. The control command may be configured to control the target device to execute an imaging control process based on the imaging route.

In some embodiments, the first generating processor 4002 generating the control command based on the imaging route may include:

obtaining an imaging command, the imaging command including one or more of an imaging starting command, an imaging pausing command, or an imaging terminating command; and

generating the control command corresponding to the imaging route based on the imaging command.

In some embodiments, the first generating processor 4002 generating the control command based on the imaging route may include:

obtaining a preview command, the preview command including one or more of a preview starting command, a preview pausing command, or a preview terminating command; and

generating the control command corresponding to the imaging route based on the preview command.

In some embodiments, the first generating processor 4002 generating the control command based on the imaging route may include:

obtaining a selection command, the selection command being configured to select a target location point from location point information; and

generating a control command corresponding to the imaging route based on the selected target location point, the control command being configured to control the target device to move to the selected target location point.

In some embodiments, the first generating processor 4002 may be configured to obtain one or more imaging parameters while imaging between at least two location points. The one or more imaging parameters may include one or more of an imaging time interval parameter, an imaging time duration parameter, an imaging angle parameter, an imaging quantity parameter, or a playback time parameter. The first generating processor 4002 may be configured to generate a control command based on the one or more imaging parameters. The control command may be configured to control the target device to execute an imaging control process based on the one or more imaging parameters.

In some embodiments, the first generating processor 4002 may be configured to obtain imaging adjustment information. The imaging adjustment information may include one or more of the following: adjustment information for the imaging time interval parameter, adjustment information for the imaging time duration parameter, adjustment information for the imaging angle parameter, adjustment information for the imaging quantity parameter, or adjustment information for the playback time parameter. The first generating processor 4002 may be configured to generate a control command based on the imaging adjustment information. The control command may be configured to control the target device to execute an imaging control process based on the imaging parameters.

In some embodiments, the first generating processor 4002 generating the control command based on the one or more imaging parameters may include:

obtaining a preview command including one or more of a preview starting command, a preview pausing command, or a preview terminating command; and

generating the control command corresponding to the one or more imaging parameters based on the preview command.

In some embodiments, the first generating processor 4002 generating the control command based on the one or more imaging parameters may include:

obtaining an imaging command including one or more of an imaging starting command, an imaging pausing command, or an imaging terminating command; and

generating the control command corresponding to the one or more imaging parameters based on the imaging command.

In some embodiments, the first generating processor 4002 may be configured to obtain one or more imaging parameters based on at least two location points. The one or more imaging parameters may include one or more of: a time interval parameter for panorama imaging, an angle location parameter for panorama imaging, an imaging scope parameter for panorama imaging, or an imaging quantity (e.g., including photo quantity) parameter for panorama imaging. The first generating processor 4002 may be configured to generate the control command based on the one or more imaging parameters. The control command may be configured to control the target device to execute an imaging control process based on the one or more imaging parameters.

In some embodiments, the first generating processor 4002 generating the control command based on the one or more imaging parameters may include:

obtaining a preview command including one or more of a preview starting command, a preview pausing command, or a preview terminating command; and

generating the control command corresponding to the one or more imaging parameters based on the preview command.

In some embodiments, the first generating processor 4002 generating the control command based on the one or more imaging parameters may include:

obtaining an imaging command including one or more of an imaging starting command, an imaging pausing command, or an imaging terminating command; and

generating the control command corresponding to the one or more imaging parameters based on the imaging command.

In some embodiments, the first generating processor 4002 may be configured to obtain one or more imaging parameters at at least two location points. The imaging parameters may include one or more of a location point adding parameter, an imaging angle parameter, an imaging time duration parameter, or an imaging speed parameter. The first generating processor 4002 may generate a control command based on the one or more imaging parameters. The control command may be configured to control the target device to execute an imaging control process based on the one or more imaging parameters.

In some embodiments, the first generating processor 4002 generating the control command based on the one or more imaging parameters may include:

obtaining an adding command configured to add a new location point at a selected target location point; and

generating a control command corresponding to the one or more imaging parameters based on the adding command, the control command configured to control the target device to execute the imaging control process at the selected target location point.

In some embodiments, the first generating processor 4002 generating the control command based on the one or more imaging parameters may include:

obtaining an imaging command including one or more of an imaging starting command, a changing target location imaging command, or an imaging terminating command; and

generating the control command corresponding to the one or more imaging parameters based on the imaging command, the control command being configured to control the target device to execute the imaging control process at the selected target location point.

In some embodiments, the terminal device may obtain location point information through the first acquiring processor 4001. The terminal device may generate, through the first generating processor 4002, the control command that includes one or more imaging parameters based on the location point information. The terminal device may transmit, through the first transmitting processor 4003, the control command to the target device. The target device may execute the imaging control process based on the one or more imaging parameters, thereby realizing imaging control operations and improving the imaging efficiency and flexibility.

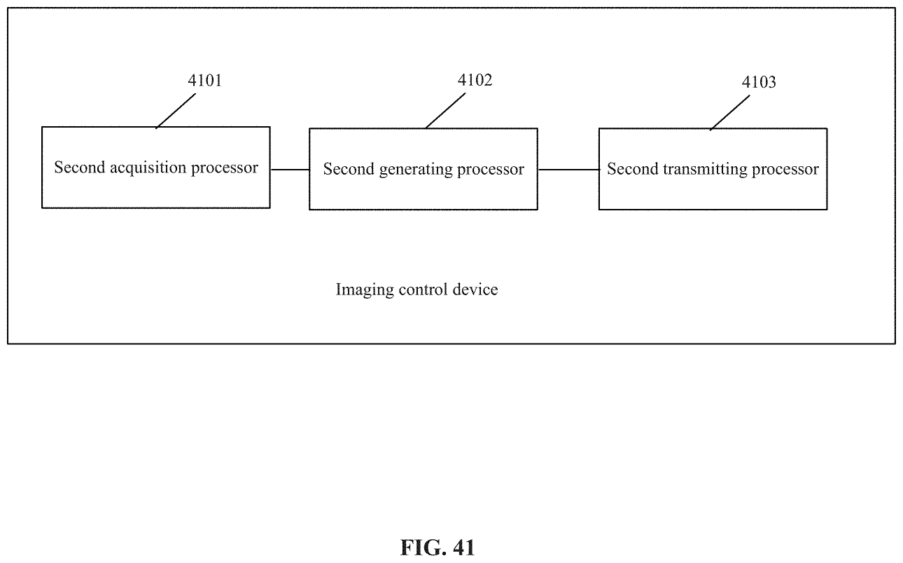

FIG. 41 is a schematic diagram of an imaging control device. The imaging control device may include a second acquiring processor 4101, a second generating processor 4102, and a second transmitting processor 4103.

The second acquiring processor 4101 may be configured to obtain control information input from a remote control interface. The remote control interface may include one or more of an angle button, a speed button, a remote control mode switching button, or an imaging mode switching button.

The second generating processor 4102 may be configured to generate a control command based on the operations received or input through the remote control interface; the control command including one or more imaging parameters.

The second transmitting processor 4103 may be configured to transmit the control command to the target device, the control command being configured to control the target device to execute an imaging control process based on the one or more imaging parameters.

In some embodiments, when the remote control interface is in a first operating mode, the second generating processor 4102 may generate an imaging angle parameter based on a user operation on an angle button. The second generating processor 4102 may generate a control command based on the imaging angle parameter. The control command may be configured to control the target device to execute the imaging control process based on the imaging angle parameter.

In some embodiments, when the remote control interface is in a second operating mode, the second generating processor 4102 may generate an imaging parameter based on a user operation on at least one of the angle button or the speed button. The imaging parameter may include at least one of an imaging angle parameter or an imaging speed parameter. The second generating processor 4102 may generate a control command based on the imaging angle parameter. The control command may be configured to control the target device to execute the imaging control process based on the imaging angle parameter.

In some embodiments, the second generating processor 4102 may be configured to obtain a user operation on the remote control mode switching button provided on the remote control interface. The second generating processor 4102 may generate a switching control command based on the user operation on the remote control mode switching button. The switching control command may be configured to control the target device to switch from the first operating mode to the second operating mode.

In some embodiments, the second generating processor 4102 may be configured to obtain a user operation on the imaging mode switching button provided on the remote control interface. The second generating processor 4102 may generate a switching control command based on the user operation on the imaging mode switching button. The switching control command may be configured to control the target device to execute a switching operation between a photo mode and a video mode.

In some embodiments, the terminal device may obtain, through the second acquiring processor 4101, control information input through the remote control interface. The terminal device may generate, through the second generating processor, a control command based on an operation on the remote control interface. The terminal device may transmit, through the second transmitting processor 4103, the control command to the target device, thereby realizing imaging control operations, and improving the imaging efficiency and flexibility.

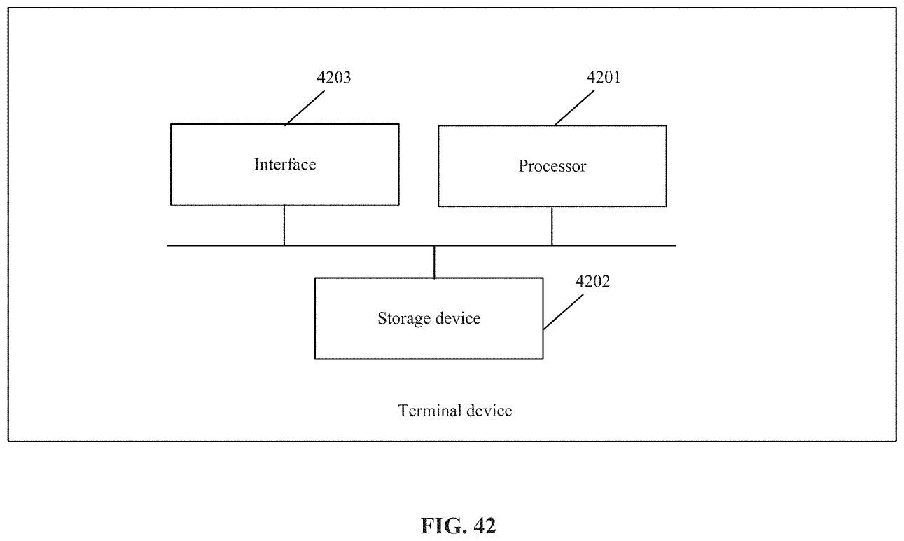

FIG. 42 is a schematic diagram of a terminal or terminal device. As shown in FIG. 42, the terminal device may include at least one processor 4201, such as a central processing unit (“CPU”), at least one interface 4203, and a storage device 4202. The interface 4203 may include a display, a keyboard, a standard wired interface, or a wireless interface. The storage device 4202 may include non-transitory computer-readable media. For example, the storage device 4202 may include a volatile memory, such as a random access memory (“RAM”). The storage device 4202 may include a non-volatile memory, such as a read-only memory (“ROM”), a flash memory, a hard disk drive (“HDD”), or a solid-state drive (“SSD”). The storage device 4202 may include any combination of the above-mentioned different types of storage devices. In some embodiments, the storage device may be at least one storage device disposed far away from the processor 4201. The storage device 4202 may be configured to store a set of computer program code. The processor 4201 may retrieve the computer program code stored in the storage device 4202, and may execute the code to perform the following operations:

obtaining location point information, the location point information being determined based on angle data;

generating a control command based on the location point information, the control command including one or more imaging parameters; and

transmitting the control command to a target device, the control command being configured to control the target device to execute an imaging control process based on the one or more imaging parameters.

In some embodiments, the processor 4201 may be configured to execute the code to perform the following operations:

generating an imaging route based on angle data corresponding to location point information of at least two location points; and

generating a control command based on the imaging route, the control command being configured to control the target device to execute an imaging control process based on the imaging route.

In some embodiments, the processor 4201 may be configured to execute the code to perform the following operations:

obtaining an imaging command including one or more of an imaging starting command, an imaging pausing command, or an imaging terminating command; and

generating a control command corresponding to the imaging route based on the imaging command.

In some embodiments, the processor 4201 may be configured to execute the code to perform the following operations:

obtaining a preview command, the preview command including one or more of a preview starting command, a preview pausing command, or a preview terminating command; and

generating a control command corresponding to the imaging route based on the preview command.

In some embodiments, the processor 4201 may be configured to execute the code to perform the following operations:

obtaining a selection command, the selection command being configured to select a target location point from location point information; and

generating a control command corresponding to the imaging route based on the selected target location point, the control command being configured to control the target device to move to the selected target location point.

In some embodiments, the processor 4201 may be configured to execute the code to perform the following operations:

obtaining one or more imaging parameters while imaging between at least two location points, the one or more imaging parameters including one or more of an imaging time interval parameter, an imaging time duration parameter, an imaging angle parameter, an imaging quantity parameter, or a playback time parameter; and

generating a control command based on the one or more imaging parameters, the control command being configured to control the target device to execute an imaging control process based on the one or more imaging parameters.

In some embodiments, the processor 4201 may be configured to execute the code to perform the following operations:

obtaining imaging adjustment information including one or more of adjustment information for imaging time interval parameter, adjustment information for imaging time duration parameter, adjustment information for imaging angle parameter, adjustment information for imaging quantity parameter, or adjustment information for playback time parameter; and

generating a control command based on the imaging adjustment information, the control command being configured to control the target device to execute an imaging control process based on the one or more imaging parameters.

In some embodiments, the processor 4201 may be configured to execute the code to perform the following operations:

obtaining a preview command including one or more of a preview starting command, a preview pausing command, or a preview terminating command; and

generating a control command corresponding to the one or more imaging parameters based on the preview command.

In some embodiments, the processor 4201 may be configured to execute the code to perform the following operations:

obtaining an imaging command including one or more of an imaging starting command, an imaging pausing command, or an imaging terminating command; and

generating a control command corresponding to the one or more imaging parameters based on the imaging command.

In some embodiments, the processor 4201 may be configured to execute the code to perform the following operations:

obtaining one or more imaging parameters based on at least two location points, the one or more imaging parameters including one or more of: a time interval parameter for panorama imaging, an angle location parameter for panorama imaging, an imaging scope parameter for panorama imaging, or an imaging quantity (e.g., photo quantity) parameter for panorama imaging; and

generating a control command based on the one or more imaging parameters, the control command being configured to control the target device to execute an imaging control process based on the one or more imaging parameters.

In some embodiments, the processor 4201 may be configured to execute the code to perform the following operations:

obtaining a preview command including one or more of a preview starting command, a preview pausing command, or a preview terminating command; and

generating a control command corresponding to the one or more imaging parameters based on the preview command.

In some embodiments, the processor 4201 may be configured to execute the code to perform the following operations:

obtaining an imaging command including one or more of an imaging starting command, an imaging pausing command, or an imaging terminating command; and

generating a control command corresponding to the one or more imaging parameters based on the imaging command.

In some embodiments, the processor 4201 may be configured to execute the code to perform the following operations:

obtaining one or more imaging parameters at at least two location points, the one or more imaging parameters including one or more of a location point adding parameter, an imaging angle parameter, an imaging time duration parameter, or an imaging speed parameter; and

generating a control command based on the one or more imaging parameters, the control command being configured to control the target device to execute an imaging control process based on the one or more imaging parameters.

In some embodiments, the processor 4201 may be configured to execute the code to perform the following operations:

obtaining an adding command, the adding command being configured to add a new location point at a selected target location point; and

generating a control command corresponding to the one or more imaging parameters based on the adding command, the control command being configured to control the target device to execute an imaging control process at the selected target location point.

In some embodiments, the processor 4201 may be configured to execute the code to perform the following operations:

obtaining an imaging command including one or more of an imaging starting command, a changing target location imaging command, or an imaging terminating command; and

generating a control command corresponding to the one or more imaging parameters based on the imaging command, the control command configured to control the target device to execute an imaging control process at the selected target location point.

In some embodiments, the processor 4201 may be configured to execute the code to perform the following operations:

In some embodiments, the storage device may be configured to store a set of computer program code, and the processor 4201 may be configured to retrieve the computer program code stored in the storage device 4202 and to execute the code to perform the following operations:

obtaining control information input through a remote control interface, the remote control interface including one or more of an angle button, a speed button, a remote control mode switching button, or an imaging mode switching button;

generating a control command based on operations on the remote control interface that generate the control information, the control command including one or more imaging parameters; and

transmitting the control command to the target device, the control command configured to control the target device to execute an imaging control process based on the one or more imaging parameters.

In some embodiments, the processor 4201 may be configured to execute the code to perform the following operations:

when the remote control interface is in the first operating mode, generating an imaging angle parameter based on a user operation on the angle button; and

generating a control command based on the imaging angle parameter, the control command configured to control the target device to execute an imaging control process based on the imaging angle parameter.

In some embodiments, the processor 4201 may be configured to execute the code to perform the following operations:

when the remote control interface is in the second operating mode, generating an imaging parameter based on a user operation on at least one of the angle button or the speed button, the imaging parameter including at least one of the angle parameter or the speed parameter; and

generating a control command based on the imaging angle parameter, the control command configured to control the target device to execute an imaging control process based on the imaging angle parameter.

In some embodiments, the processor 4201 may be configured to execute the code to perform the following operations:

obtaining a user operation on the remote control mode switching button provided on the remote control interface; and

generating a switching control command based on the user operation on the remote control mode switching button, the switching control command configured to control the target device from the first operating mode to the second operating mode.

In some embodiments, the processor 4201 may be configured to execute the code to perform the following operations:

In some embodiments, the processor 4201 may be configured to execute the code to perform the following operations:

obtaining a user operation on the imaging mode switching button provided on the remote control interface; and

generating a switching control command based on the user operation on the imaging mode switching button, the switching control command configured to control the target device to execute a switching operation between a photo mode and a video mode.

A person having ordinary skills in the art can appreciate that all or part of the disclosed method may be realized using computer software instructing relevant hardware. The software may be stored in a non-transitory computer-readable medium as instructions or codes. When the software is executed by a processor, the processor may perform steps of the disclosed method. In some embodiments, the software may be stored in a magnetic disk, an optical disk, a read-only memory (“ROM”), or a random access memory (“RAM”), etc.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. An imaging control method, comprising:
obtaining location point information, the location point information being determined based on angle data;
generating a control command based on the location point information, the control command including an imaging parameter; and
transmitting the control command to a target device, the control command configured to control the target device to execute an imaging control process based on the imaging parameter.

2. The imaging control method of claim 1,
wherein the location point information comprises location point information of at least two location points, and
wherein generating the control command based on the location point information comprises:
generating an imaging route based on the angle data corresponding to the location point information of the at least two location points; and
generating the control command based on the imaging route, the control command configured to control the target device to execute the imaging control process based on the imaging route.

3. The imaging control method of claim 2, wherein generating the control command based on the imaging route comprises:
obtaining an imaging command, the imaging command comprising one or more of an imaging starting command, an imaging pausing command, or an imaging terminating command; and
generating the control command corresponding to the imaging route based on the imaging command.

4. The imaging control method of claim 2, wherein generating the control command based on the imaging route comprises:
obtaining a preview command, the preview command comprising one or more of a preview starting command, a preview pausing command, or a preview terminating command; and
generating the control command corresponding to the imaging route based on the preview command.

5. The imaging control method of claim 2, wherein generating the control command based on the imaging route comprises:
obtaining a selection command, the selection command configured to select a target location point from the location point information; and
generating the control command corresponding to the imaging route based on the selected target location point, the control command configured to control the target device to move to the selected target location point.

6. The imaging control method of claim 1,
wherein the location point information comprises location point information of at least two location points, and
wherein generating the control command based on the location point information comprises:
obtaining the imaging parameter while imaging between at least two location points, the imaging parameter comprising one or more of an imaging time interval parameter, an imaging time duration parameter, an imaging angle parameter, an imaging quantity parameter, or a playback time parameter; and
generating the control command based on the imaging parameter, the control command configured to control the target device to execute the imaging control process based on the imaging parameter.

7. The imaging control method of claim 6, wherein generating the control command based on the location point information comprises:
obtaining imaging adjustment information, the imaging adjustment information comprising one or more of: adjustment information for the imaging time interval parameter, adjustment information for the imaging time duration parameter, adjustment information for the imaging angle parameter, adjustment information for the imaging quantity parameter, or adjustment information for the playback time parameter; and
generating the control command based on the imaging adjustment information, the control command configured to control the target device to execute the imaging control process based on the imaging parameter.

8. The imaging control method of claim 6, wherein generating the control command based on the imaging parameter comprises:
obtaining a preview command, the preview command comprising one or more of a preview starting command, a preview pausing command, or a preview terminating command; and
generating the control command corresponding to the imaging parameter based on the preview command.

9. The imaging control method of claim 6, wherein generating the control command based on the imaging parameter comprises:
obtaining an imaging command, the imaging command comprising one or more of an imaging starting command, an imaging pausing command, or an imaging terminating command; and
generating the control command corresponding to the imaging parameter based on the imaging command.

10. The imaging control method of claim 1,
wherein the location point information comprises location point information of at least two location points, and
wherein generating the control command based on the location point information comprises:
obtaining the imaging parameter based on the location point information of the at least two location points, the imaging parameter comprising one or more of a time interval parameter for panorama imaging, an angle location parameter for panorama imaging, an imaging scope parameter for panorama imaging, or an imaging quantity parameter for panorama imaging; and
generating the control command based on the imaging parameter, the control command configured to control the target device to execute the imaging control process based on the imaging parameter.

11. The imaging control method of claim 10, wherein generating the control command based on the imaging parameter comprises:
obtaining a preview command, the preview command comprising one or more of a preview starting command, a preview pausing command, or a preview terminating command; and
generating the control command corresponding to the imaging parameter based on the preview command.

12. The imaging control method of claim 10, wherein generating the control command based on the imaging parameter comprises:
obtaining an imaging command, the imaging command comprising one or more of an imaging starting command, an imaging pausing command, or an imaging terminating command; and
generating the control command corresponding to the imaging parameter based on the imaging command.

13. The imaging control method of claim 1, wherein generating the control command based on the location point information comprises:
obtaining the imaging parameter at at least two location points, the imaging parameter comprising one or more of a location point adding parameter, an imaging angle parameter, an imaging time duration parameter, or an imaging speed parameter; and
generating the control command based on the imaging parameter, the control command configured to control the target device to execute the imaging control process based on the imaging parameter.

14. The imaging control method of claim 13, wherein generating the control command based on the imaging parameter comprises:
obtaining an adding command, the adding command configured to add a new location point at a selected target location point; and
generating a control command corresponding to the imaging parameter based on the adding command, the control command configured to control the target device to execute the imaging control process at the selected target location point.

15. The imaging control method of claim 14, wherein generating the control command based on the imaging parameter comprises:
obtaining an imaging command, the imaging command comprising one or more of an imaging starting command, a changing target location imaging command, or an imaging terminating command; and
generating the control command corresponding to the imaging parameter based on the imaging command, the control command configured to control the target device to execute the imaging control process at the selected target location point.

16. An imaging control method, comprising:
obtaining control information input through a remote control interface, the remote control interface comprising one or more of an angle button, a speed button, a remote control mode switching button, or an imaging mode switching button;
generating a control command based on an operation on the remote control interface, the control command comprising an imaging parameter; and
transmitting the control command to a target device, the control command configured to control the target device to execute an imaging control process based on the imaging parameter.

17. The imaging control method of claim 16, wherein generating the control command based on the operation on the remote control interface comprises:
when the remote control interface is in a first operating mode, generating an imaging angle parameter based on an operation on the angle button; and
generating the control command based on the imaging angle parameter, the control command configured to control the target device to execute the imaging control process based on the imaging angle parameter.

18. The imaging control method of claim 17, wherein generating the control command based on the operation on the remote control interface comprises:
when the remote control interface is in a second operating mode, generating the imaging parameter based on an operation on at least one of the angle button or the speed button, the imaging parameter comprising at least one of the imaging angle parameter or an imaging speed parameter; and
generating the control command based on the imaging angle parameter, the control command configured to control the target device to execute the imaging control process based on the imaging angle parameter.

19. The imaging control method of claim 16, wherein generating the control command based on the operation on the remote control interface comprises:
obtaining an operation on the remote control mode switching button on the remote control interface; and
generating a switching control command based on the operation on the remote control mode switching button, the switching control command configured to control the target device to switch from a first operating mode to a second operating mode.

20. The imaging control method of claim 16, wherein generating the control command based on the operation on the remote control interface comprises:
obtaining an operation on the imaging mode switching button on the remote control interface; and
generating a switching control command based on the operation on the imaging mode switching button, the switching control command configured to control the target device to switch between a photo mode and a video mode.
